(19) United States
(12) Patent Application Publication
(10) Pub. No.: US 2007/0027280 A1
(43) Pub. Date: Feb. 1, 2007

(54) Multifunctional substituted monomers and polyarylene compositions therefrom

(76) Inventors: Jerry L Hahnfeld, Midland, MI (US); Robert E. Hefner JR., Freeport, TX (US); Yongfu Li, Midland, MI (US); Q. Jason Niu, Midland, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/549,381

(22) PCT Filed: Apr. 1, 2004
(86) PCT No.: PCT/US04/09972

§ 371 Date: Jun. 30, 2006

Related U.S. Application Data
(60) Provisional application No. 60/459,732, filed on Apr. 2, 2003.

(51) Int. Cl. C08F 38/00

(52) U.S. Cl. 526/285

(57) ABSTRACT

A compound useful in the formation of polymeric dielectric films for semiconductor devices and the resulting cured films and devices, said compound comprising i) three or more dienophile groups (A-functional groups) and ii) a single ring structure comprising two conjugated carbon-to-carbon double bonds and a leaving group L (collectively referred to as a B-functional group), characterized in that one A-functional group of one molecule of the compound is capable of reaction under cycloaddition reaction conditions with the B-functional group of a second molecule and elimination of the leaving group L, to thereby form a polymer.

This invention was made with United States Government support under Cooperative Agreement No. 70NANB8H4013 awarded by NIST. The United States Government has certain rights in the invention.

### FIELD OF THE INVENTION

This invention relates to compositions having at least two different reactive functional groups and to aromatic polymers made from these monomers. The resulting polymers are useful in making low dielectric constant insulating layers in microelectronic devices.

### BACKGROUND OF THE INVENTION

Polyarylene resins, such as those disclosed in U.S. Pat. No. 5,965,679 (Godschalx et al.) are low dielectric constant materials suitable for use as insulating films in semiconductor devices, especially integrated circuits. Such polyarylene compounds are prepared by reacting polyfunctional compounds having two or more cyclopentadienone groups with polyfunctional compounds having two or more aromatic acetylene groups, at least some of the polyfunctional compounds having three or more reactive groups. Certain single component reactive monomers which contained one cyclopentadienone group together with two aromatic acetylene groups, specifically 3,4-bis(3-(phenylethynyl)phenyl)-2,5-dicyclopentadienone and 3,4-bis(4-(phenylethynyl)phenyl)-2,5-dicyclopentadienone, and polymers made from such monomers were also disclosed in the foregoing reference. Typically, these materials are B-staged in solvent solution and then spin coated onto a substrate followed by a hotplate baking step and a subsequent curing (vitrification) to 400-450° C. in an oven to complete the cure.

In U.S. Pat. No. 6,359,091, it was taught that it may be desirable to adjust the modulus of polymers as taught in Godschalx et al., by adjusting the ratio of the reactants in Godschalx or by adding other reactive species to the monomers or to the partially polymerized product of Godschalx. U.S. Patent 6,172,128 teaches aromatic polymers containing cyclopentadienone groups that may react with aromatic polymers containing phenylacetylene groups to provide branched or cross-linked polymers. U.S. Pat. No. 6,156,812 shows polymers which contain both cyclopentadienone groups and phenylacetylene groups in the backbone of the polymer. In WO00/31183, cross-linkable compositions comprising a cross-linkable hydrocarbon-containing matrix precursor and a pore forming substance (poragen) which are curable to form low dielectric constant insulating layers for semiconductor devices were disclosed. Generally, the foregoing disclosure taught the formation of improved (lower) dielectric constant insulating films by partially curing the precursor to form a matrix containing occlusions of the poragen and then removing the pore generating material to form voids or pores in the matrix material.

In Chem. Commun., (1998), 1139, and Macomolecules (2001), 34, 187 the syntheses of compounds containing one tetraphenylcyclopentadienone group and at least two triisopropylsilyl substituted acetylene groups were disclosed. In these compounds the presence of the bulky triisopropylsilyl groups make the acetylene functions inaccessible for dienophiles in a Diels-Alder or cycloaddition reaction. Accordingly, such compounds are unsuited for use as monomers and incapable of reaction to form dielectric films. Similar compounds are also disclosed in J. Org. Chem. (1997), 62, 3430.

Although the foregoing advances have led to improvements in dielectric constant of the resulting film, additional improvements in film properties are desired by the industry. In particular, curable compositions capable of providing enhanced processability, improved solubility, increased porosity, and better substrate wet out are still desired. In addition, compositions having improved physical properties are also sought.

### SUMMARY OF THE INVENTION

According to a first embodiment of the present invention there is provided a compound (monomer) comprising i) three or more dienophile groups (A-functional groups) and ii) a single ring structure comprising two conjugated carbon-to-carbon double bonds and a leaving group L (collectively referred to as a B-functional group), characterized in that one A-functional group of one molecule of the compound is capable of reaction under cycloaddition reaction conditions with the B-functional group of a second molecule and elimination of the leaving group L, to thereby form a polymer.

According to a second embodiment of this invention, there is provided a curable oligomer or polymer made by the reaction of the foregoing monomer, a mixture thereof, or a composition comprising the same under cycloaddition and elimination reaction conditions. In this embodiment of the invention the curable oligomer or polymer comprises some remainder of the two reactive functional groups, primarily the A-functional groups, as pendant groups, terminal groups, or as groups within the backbone of the oligomer or polymer.

According to a third embodiment this invention is a highly crosslinked polymer made by final cure of the foregoing curable oligomers or polymers or compositions comprising the same.

According to a fourth embodiment, this invention is a composition comprising the curable oligomer or polymer of the second embodiment and a poragen.

According to a fifth embodiment of the invention there is provided a method of forming a solid article comprising a vitrified polyarylene polymer which method comprises providing the above monomer, mixture of monomers, or a composition comprising the same; partially polymerizing the monomer under cycloaddition reaction conditions, optionally in the presence of a solvent and/or a poragen thereby forming a curable oligomer or polymer containing composition; and curing the composition to form a solid polyarylene polymer, optionally accompanied or followed by removal of the solvent and/or poragen.

According to a sixth embodiment, this invention is an article made by the above method or a construct containing such article.

According to a seventh embodiment of the invention, the foregoing article is a film and the construct is a semiconductor device, such as an integrated circuit, incorporating the film as an insulator between circuit lines or layers of circuit lines therein.

The mixture of monomers and oligomers resulting from B-staging are soluble in typical solvents used in fabrication of semiconductor devices, and may be employed in formulations that may be spin coated onto substrates and vitrified at a lower temperature and/or form a system which does not suffer a significant loss in modulus at elevated temperatures, due to higher cross4ink density of the polymer product. Such compositions are desirable in order to obtain highly porous films having reduced potential for pore collapse or coalescence during the chip manufacturing process and that upon vitrification, result in a desirable low dielectric constant, insulating film.

### DETAILED DESCRIPTION OF THE INVENTION

For purposes of United States patent practice, the contents of any patent, patent application or publication referenced herein is hereby incorporated by reference in its entirety herein, especially with respect to its disclosure of monomer, oligomer or polymer structures, synthetic techniques and general knowledge in the art. If appearing herein, the term “comprising” and derivatives thereof is not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability. The term “consisting of”, if used, excludes any component, step or procedure not specifically delineated or listed. The term “or”, unless stated otherwise, refers to the listed members individually as well as in any combination.

As used herein the term “aromatic” refers to a polyatomic, cyclic, ring system containing (4δ+2) π-electrons, wherein δ is an integer greater than or equal to 1. The term “fused” as used herein with respect to a ring system containing two or more polyatomic, cyclic rings means that with respect to at least two rings thereof, at least one pair of adjacent atoms is included in both rings.

“A-functionality” refers to a single dienophile group.

“B-functionality” refers to the ring structure comprising two conjugated carbon-to-carbon double bonds and a leaving group L.

“B-Staged” refers to the oligomeric mixture or low molecular weight polymeric mixture resulting from partial polymerization of a monomer. Unreacted monomer may be included in the mixture.

“Cross-linkable” refers to a matrix precursor that is capable of being irreversibly cured, to a material that cannot be reshaped or reformed. Cross-linking may be assisted by UV, microwave, x-ray, or e-beam irradiation. Often used interchangeably with “thermosettable” when the cross-linking is done thermally.

“Dienophile” refers to a group that is able to react with the conjugated, double bonded carbon groups according to the present invention, preferably in a cycloaddition reaction involving elimination of the L group and aromatic ring formation.

“Inert substituent” means a substituent group which does not interfere with any subsequent desirable polymerization reaction of the monomer or B-staged oligomer and does not include further polymerizable ring structures as disclosed herein.

“Matrix precursor” means a monomer, prepolymer, or polymer, or mixtures thereof which upon curing forms a cross-linked matrix material.

“Monomer” means a polymerizable compound or mixture of polymerizable compounds.

“Matrix” refers to a continuous phase surrounding dispersed regions of a distinct composition or void.

“Poragen” refers to components which may be removed from the initially formed oligomer or polymer or, more preferably, from the vitrified (that is the fully cured or cross-linked) polymer, resulting in the formation of voids or pores in the polymer. Poragens may be removed from the matrix polymer by any suitable technique, including dissolving by solvents or, more preferably, by thermal decomposition.

The Monomers and Their Syntheses

The monomers of the present invention preferably comprise a single ring having two conjugated carbon to carbon double bonds and the leaving group, L and further substituted with three or more, preferably from 3 to 5, more preferably 3 of the foregoing dienophilic functional groups, or inertly substituted derivatives thereof. Examples of suitable ring structures include cyclopentadienones, pyrones, furans, thiophenes, pyridazines, and alkyl or aryl, including fused ring aryl, derivatives thereof.

Preferably, the ring structure is a five-membered ring where L is —O—, —S—, —(CO)—, or —(SO₂)—, or a six membered ring where L is —N═N—, or —O(CO)—. Optionally, two of the carbon atoms of the ring structure and their substituent groups taken together may form an aromatic ring, that is, the 5 or 6 membered ring structures may be fused to an aromatic ring.

Desirably, L is —(CO)— such that the ring is a cyclopentadienone group or benzcyclopentadienone group. Preferred dienophile groups are hydrocarbon groups, most preferably ethynyl or phenylethynyl groups.

Highly desirably, suitable monomers are cyclopentadienone or benzcyclopentadienone compounds substituted at two or more of the carbons forming the double bonds of the B-functional group or the carbons of a fused aromatic ring containing such double bonded carbons, with an ethynylaryl group, an arylethynylaryl group, or a di(arylethynyl)aryl group. More highly desirably, 3 or all 4 of the conjugated, double bonded carbons of a cyclopentadienone compound are substituted with an ethynylaryl group, an arylethynylaryl group, or a di(arylethynyl)aryl group. Still more highly desirably, at least one of the dienophilic substituents is a di(arylethynyl)aryl group, most preferably a 3,5-di(phenylethynyl)phenyl group.

Examples of suitable monomers according to the invention are compounds corresponding to the formula,

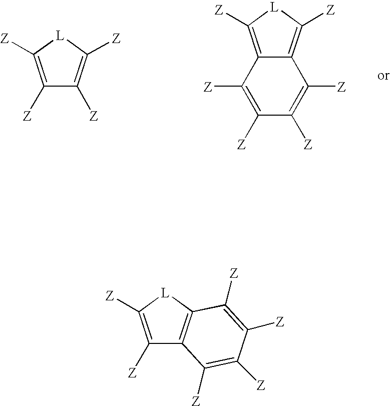

wherein L is —O—, —S—, —N═N—, —(CO)—, —(SO₂)—, or —O(CO)—, preferably —(CO)—;

Z is independently in each occurrence —W—(C≡CQ)_{q}, hydrogen, halogen, an unsubstituted or inertly substituted aromatic group, an unsubstituted or inertly substituted alkyl group, or two adjacent Z groups together with the carbons to which they are attached form a fused aromatic ring;

W is an unsubstituted or inertly substituted C₆₋₂₀ aromatic or group, preferably phenylene, p,p′-biphenylene, or 4-(4′-phenoxy)phenylene;

Q is hydrogen, an unsubstituted or inertly substituted C₆₋₂₀ aryl group, or an unsubstituted or inertly substituted C₁₋₂₀ alkyl group;

q independently each occurrence is an integer from 1 to 3; and

the number of Z substituents and q are selected to provide a total of from 3 to 10, preferably from 3-5, and most preferably 3 or 4 —C≡C-Q groups.

Preferred monomers according to the present invention are 2,3,4-tri(arylethynylaryl)-2,3,5-tri(arylethynylaryl)-, 2-di(arylethynyl)aryl-3-arylethynylaryl-, 2-di(arylethynyl)aryl-4-arylethynylaryl-, 2-di(arylethynyl)aryl-5-arylethynylaryl-, 3-di(arylethynyl)aryl-4-arylethynylaryl-, 3-di(arylethynyl)aryl-5-arylethynylaryl-, 2-arylethynylaryl-3-di(arylethynyl)aryl-, 2-arylethynylaryl-4-i(arylethynyl)aryl-, 2-arylethynylaryl-5-di(arylethynyl)aryl-, 3-arylethynylaryl-4-di(arylethynyl)aryl-, 3-arylethynylaryl-5-di(arylethynyl)aryl-, 2,3-bis(di(arylethynyl)aryl)-, 2,4-bis(di(arylethynyl)aryl)-, 2,5-bis(di(arylethynyl)aryl)-, or 3,4-bis(di(arylethynyl)aryl)-substituted cyclopentadienone compounds.

Examples of preferred compounds are those represented by the formula:

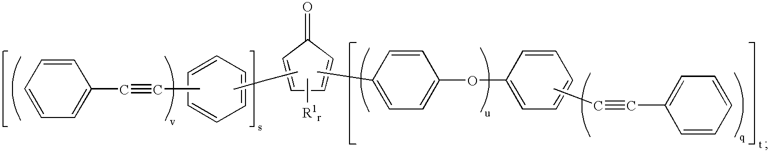

wherein R¹ is hydrogen, C₆₋₂₀ aryl or inertly substituted aryl, most preferably, hydrogen, phenyl, biphenyl, p-phenoxyphenyl or naphthyl;

q is a number from 1 to 3;

r is a number from 0 to 3;

u is 0 or 1;

v is a number from 1 to 3;

s and t are numbers from 1 to 4, and (v·s)+(q·t) is a number greater than or equal to 3; and

r+s+t=4.

Highly preferred monomers according to the present invention are substituted 2,5-diphenylcyclopentadienone compounds containing at least one arylethynyl moiety attached to a phenoxyphenyl group represented by the formulas 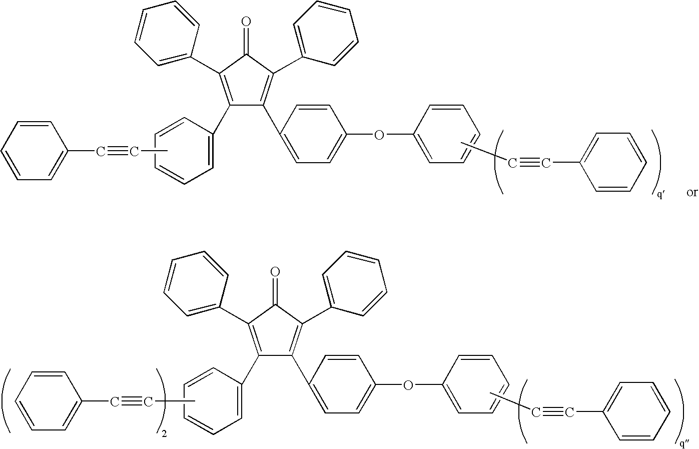
where q′ is a number from 2 to 3 and q″ is a number from 1 to 3.

The monomers of the present invention or B-staged oligomers thereof are suitably employed in a curable composition alone or as a mixture with other monomers containing two or more functional groups (or B-staged oligomers thereof) able to polymerize by means of a Diels-Alder or similar cycloaddition reaction. Examples of such other monomers include compounds having two or more cyclopentadienone functional groups and/or acetylene functional groups or mixtures thereof, such as those previously disclosed in U.S. Pat. Nos. 5,965,679 and 6,359,091. In the B-stage curing reaction, a dienophilic group reacts with the cyclic diene functionality, causing elimination of L and aromatic ring formation. Subsequent curing or vitrification may involve a similar cycloaddition or an addition reaction involving only the dienophilic functional groups.

Additional suitable monomers that may be included in a curable composition according to the present invention include compounds of the formula:

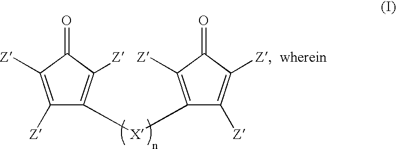

Z′ is independently in each occurrence hydrogen, an unsubstituted or inertly substituted aromatic group, an unsubstituted or inertly substituted alkyl group, or —W—(C≡C-Q)_{q};

X′ is an unsubstituted or inertly substituted aromatic group, —W—C≡C—W—, or

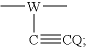

W is an unsubstituted or inertly substituted aromatic group, and

Q is hydrogen, an unsubstituted or inertly substituted C₆₋₂₀ aryl group, or an unsubstituted or inertly substituted C₁₋₂₀ alkyl group, provided that at least two of the X′ and/or Z′ groups comprise an acetylenic group,

q is an integer from 1 to 3; and

n is an integer of from 1 to 10.

Examples of the foregoing polyfunctional monomers that may be used in conjunction with the monomers of the present invention include compounds of formulas II-XXV: Formula II: 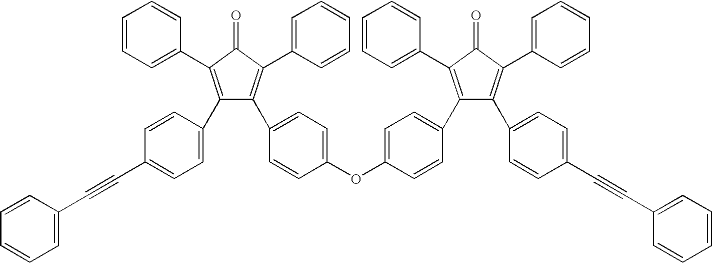
Formula III (a mixture of): 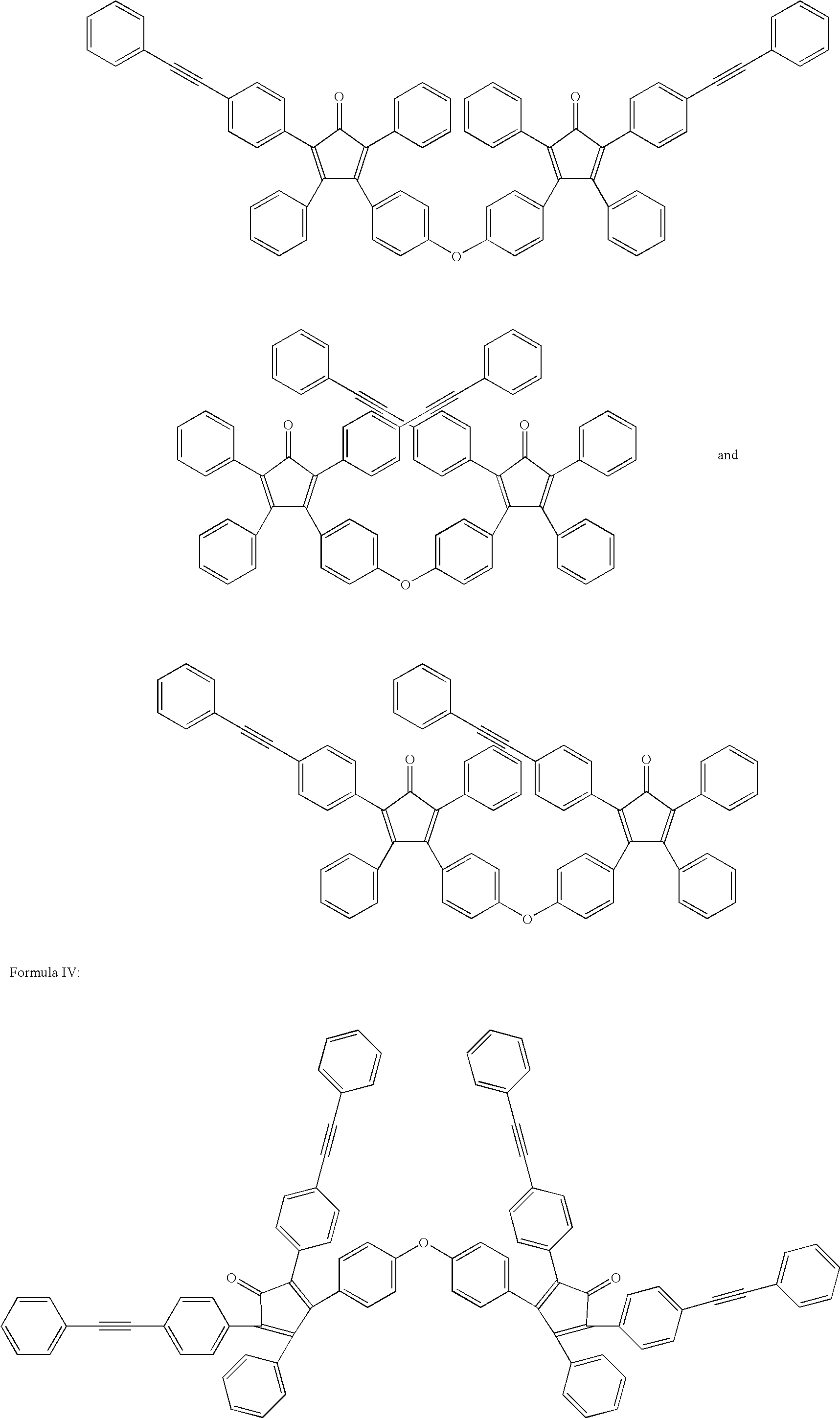 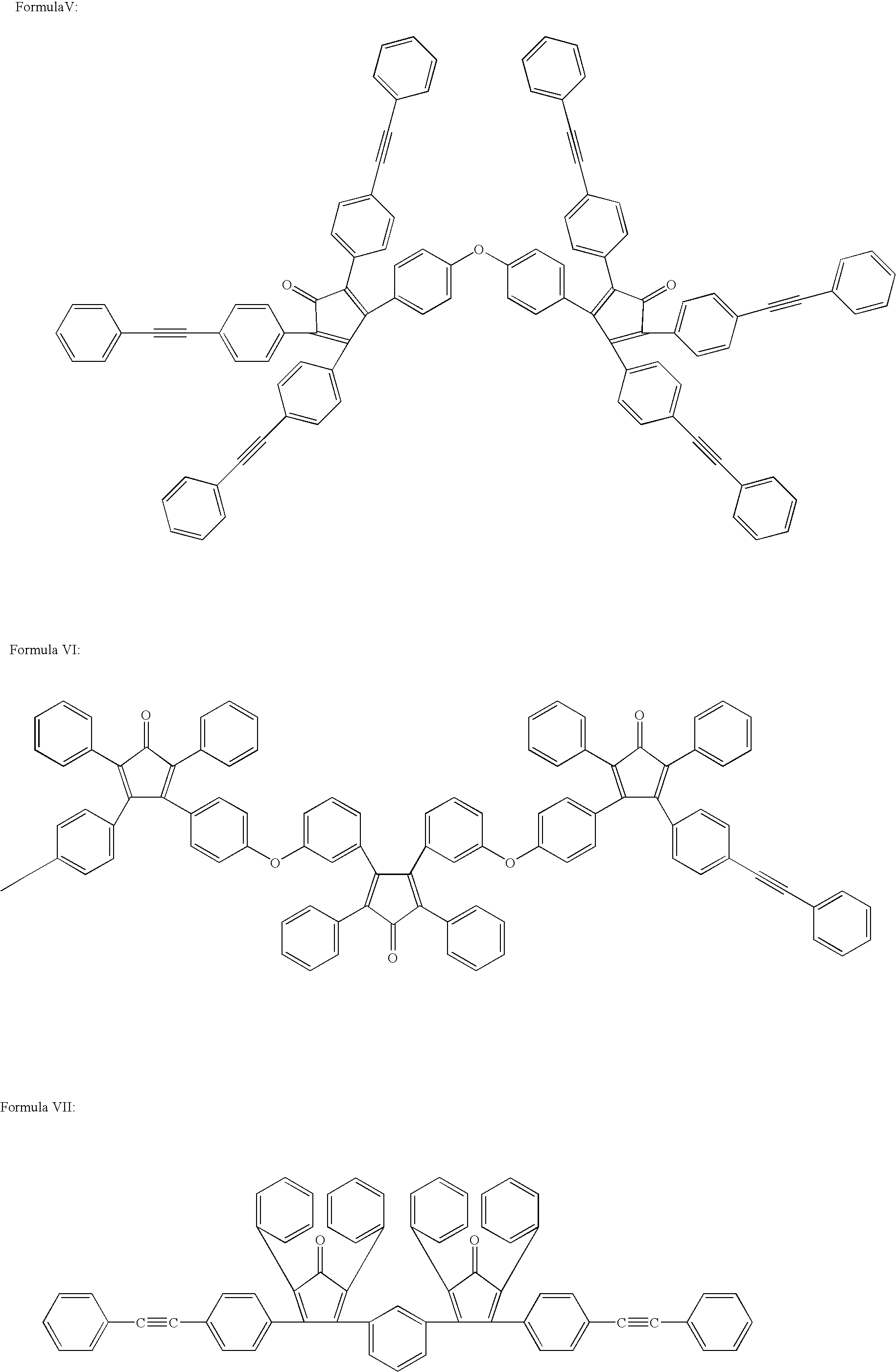 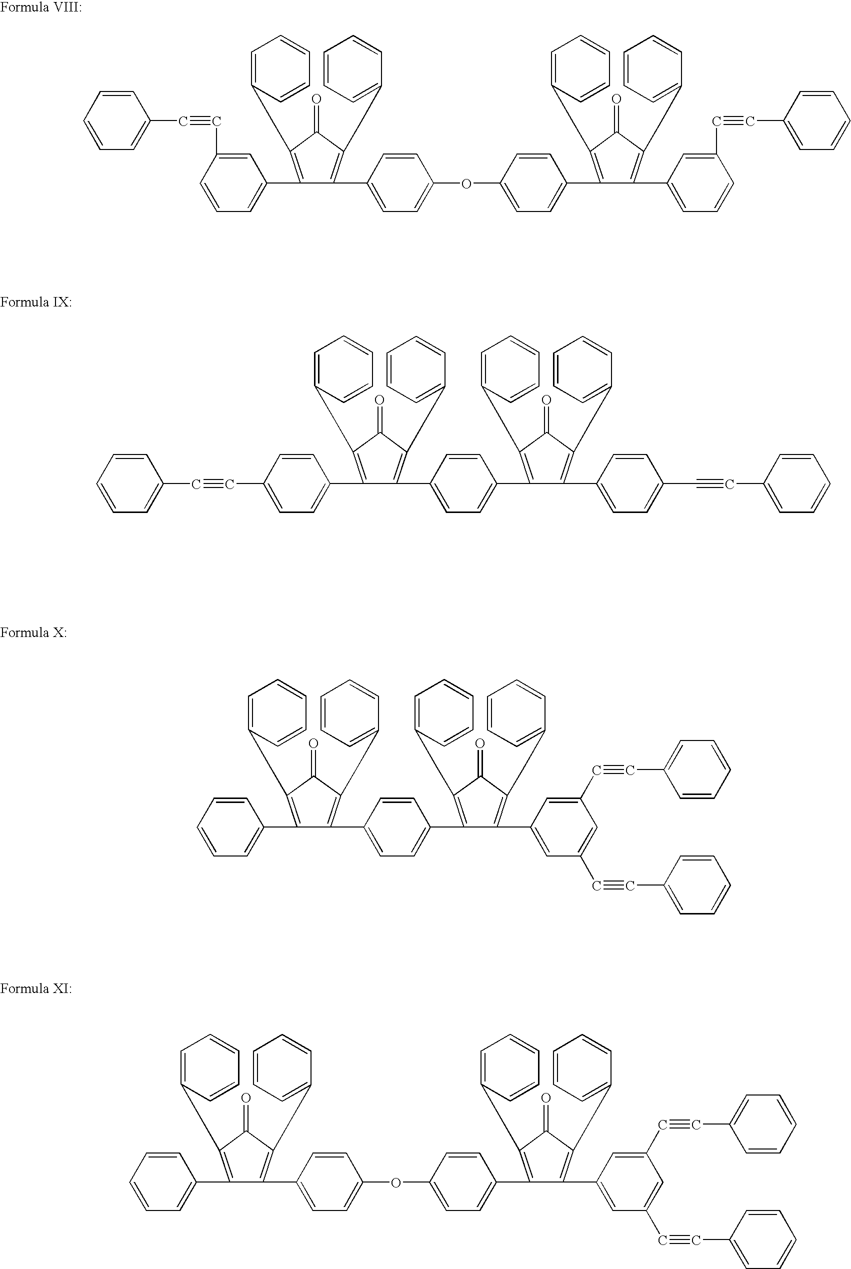 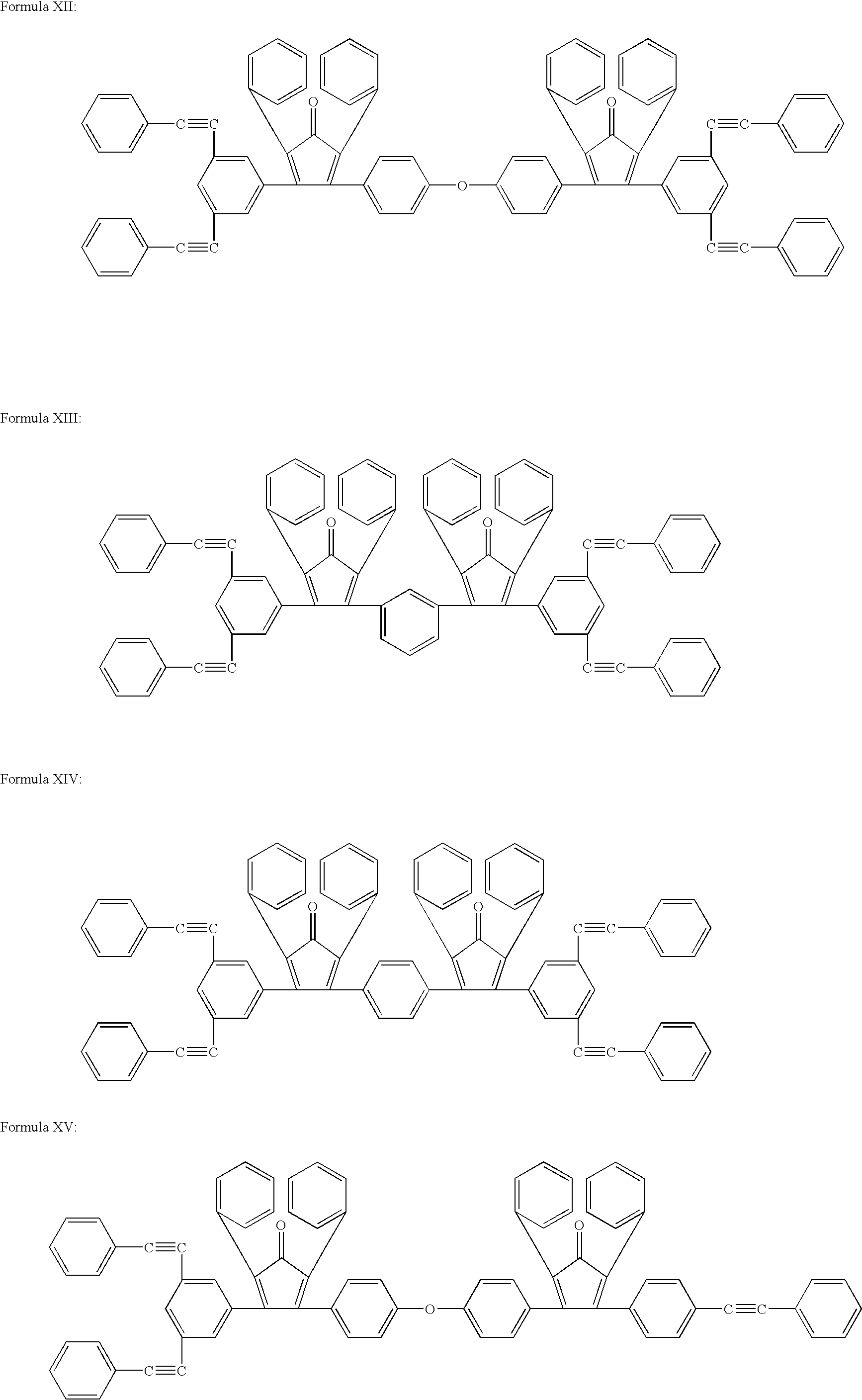 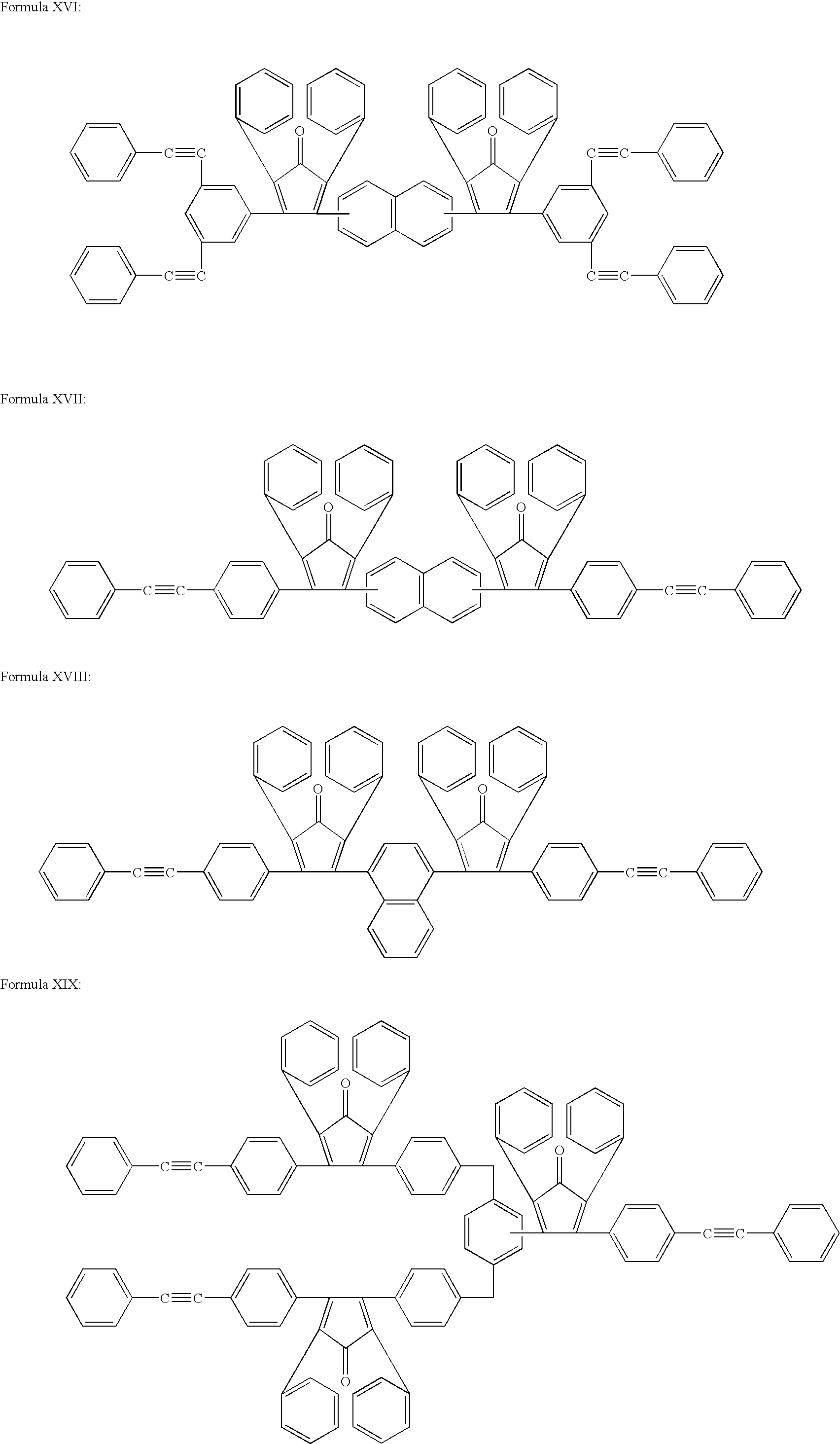
Formula XX (a mixture of): 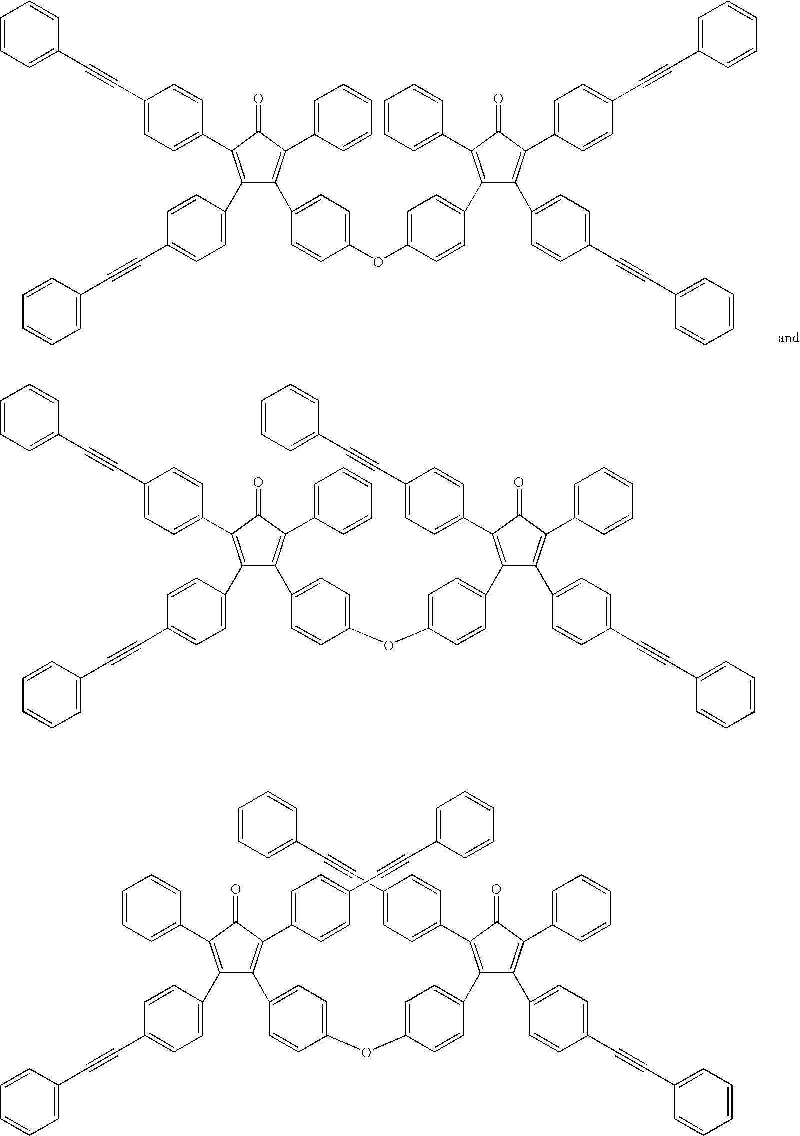
Formula XXI (a mixture of): 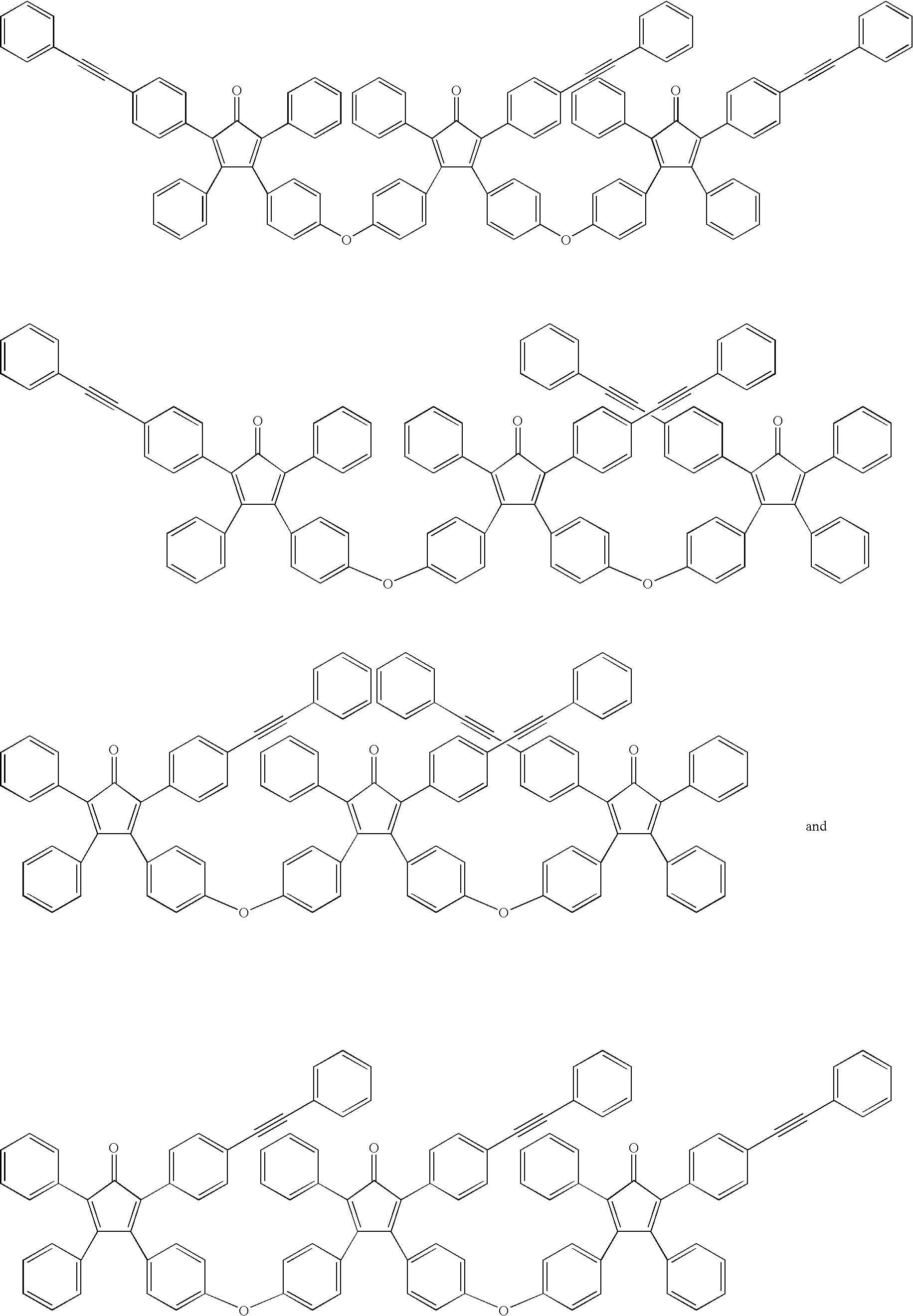
Formula XXII (a mixture of):

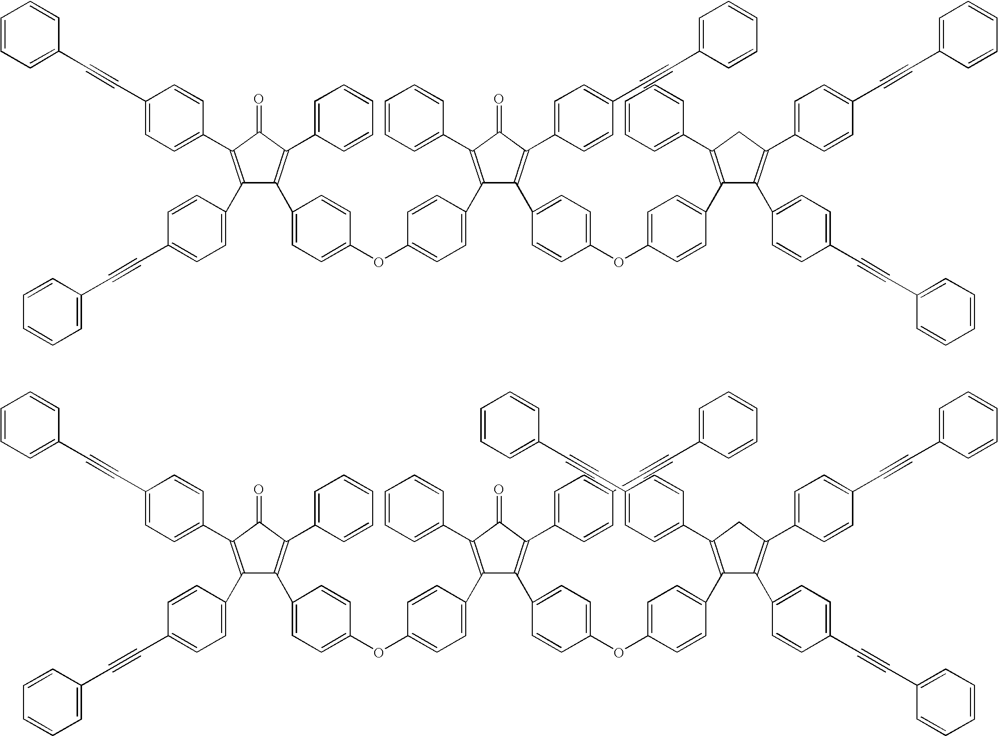

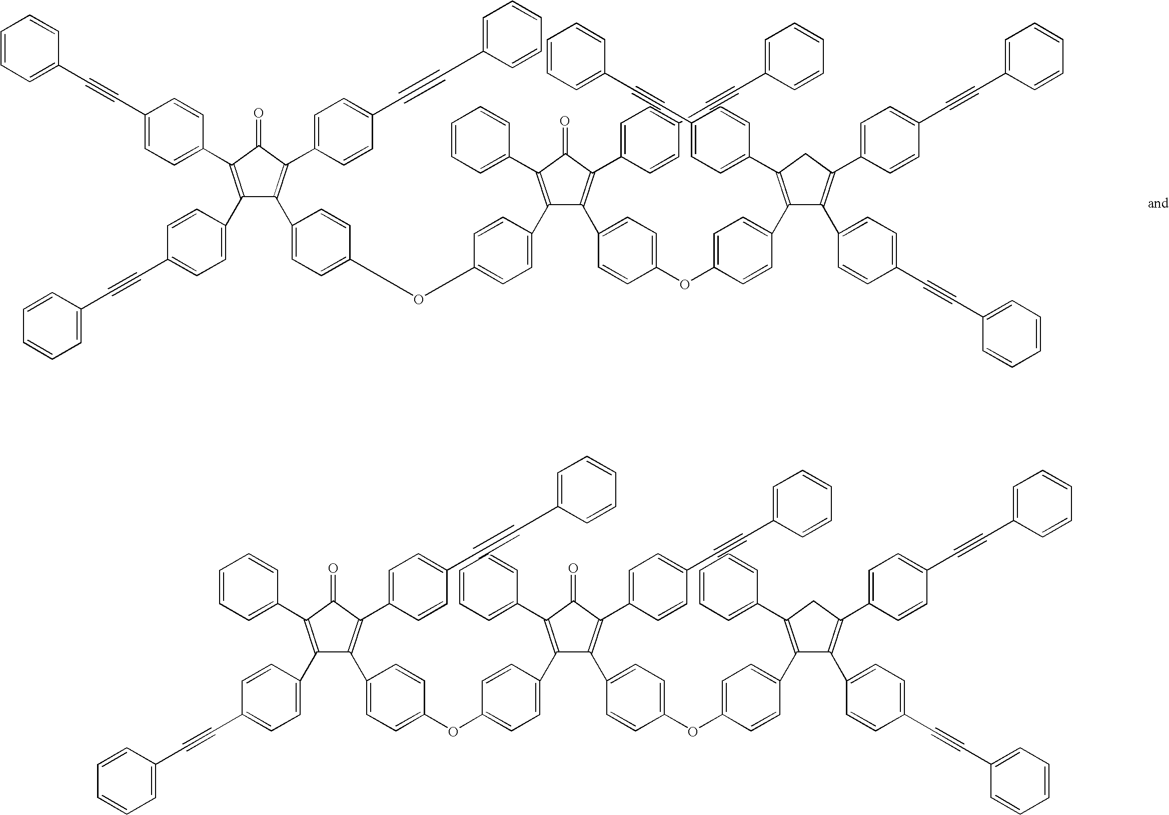

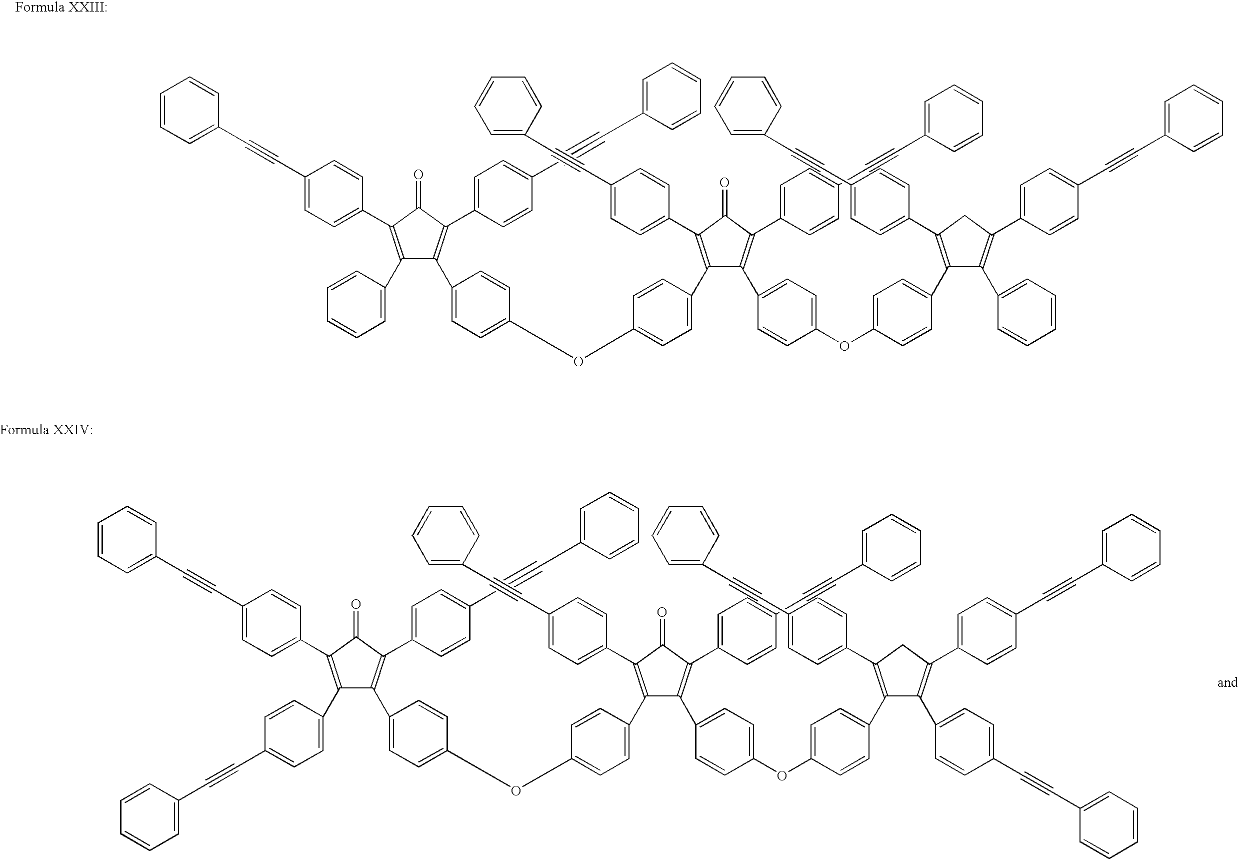

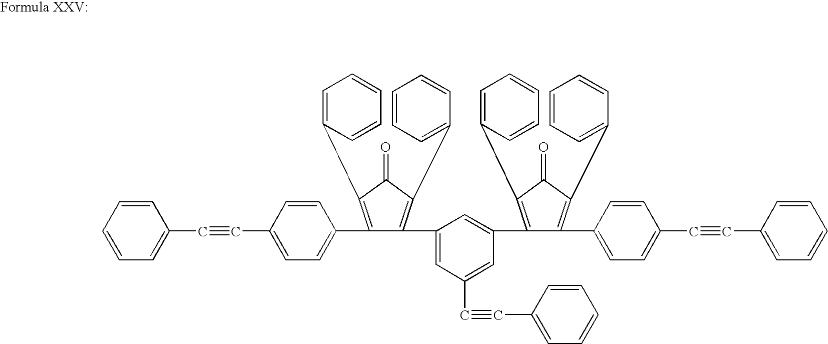

The foregoing monomers II-XXV where the ring structure is a cyclopentadienone may be made, for example, by condensation of substituted or unsubstituted benzils with substituted or unsubstituted benzyl ketones (or analogous reactions) using conventional methods such as those disclosed in: Kumar, et al. Macromolecules, (1995), 28, 124-130, Ogliaruso et al., J. Org. Chem., (1965), 30, 3354, Ogliaruso, et al., J. Org. Chem., (1963), 28, 2725, Wiesler, et al., Macromolecules, (2001), 34, 187, Baker, et al., Macromolecules. (1979), 12, 369, Tong, et al., J. Am. Chem. Soc. (1997), 119, 7291, and U.S. Pat. No. 4,400,540. Monomers having other structures may be prepared as follows: Pyrones can be prepared using conventional methods such as those shown in the following references and references cited therein: Braham et. al., Macromolecules (1978), 11, 343; Liu et. al., J. Org. Chem. (1996), 61, 6693-99; van Kerckhoven et. al., Macromolecules (1972), 5, 541; Schilling et. al., Macromolecules (1969), 2, 85; Puetter et. al., J. Prakt. Chem. (1951), 149, 183. Furans can be prepared using conventional methods such as those shown in the following references and references cited therein: Feldman et. al., Tetrahedron Lett. (1992), 47, 7101, McDonald et. al. J. Chem. Soc. Perkin Trans. (1979), 1 1893. Pyrazines can be prepared using conventional methods such as those shown in the following reference and references cited therein: Turchi et. al., Tetrahedron (1998), 1809.

In a preferred embodiment of the invention employing mixtures of the present monomers and other monomers as previously disclosed it is desirable to maintain a ratio of the corresponding A-functionality and B-functionality in the mixture such that the ratio of B-functional groups to A-functional groups in the reaction mixture is in the range of 1:10 to 10:1, and most preferably from 2:1 to 1:4. Preferably, the composition additionally comprises a solvent and most preferably also comprises a poragen.

In a further preferred embodiment a composition comprising one or more monomers according to the present invention and optionally a poragen while curing forms a polyarylene material wherein the B-staged monomer composition has a flexural storage modulus profile as measured by torsional impregnated cloth analysis (TICA) characterized in that during heating of the composition a minimum measured modulus observed in the temperature range from 250 to 450° C., Mmin, is of a greater magnitude than that shown by a conventional SiLK*-I™ material when analyzed in a similar manner, and preferably is at least 50 percent, more preferably at least 75 percent of the flexural storage modulus of the fully cured composite measured at 25° C. SiLK*-I™ is a commercially available polyarylene oligomer solution available from the Dow Chemical Company.

In the TICA method, a woven glass cloth (preferably, 0.3 mm thick, 15 mm wide, and 35 mm long) is mounted in a dynamic mechanical analyzer, such as a DuPont 983 DMA, preferably fitted with a Low Mass Vertical Clamp Accessory or equivalent functionality to enhance sensitivity. The ends of the cloth are wrapped in aluminum foil leaving 10 mm in length exposed. The cloth is then mounted in the vertical clamps of the dynamic mechanical analyzer which are set 10 mm apart. The clamps are tightened to 12 inch pounds (1.4 Nm) using a torque wrench. The cloth is impregnated using a solution comprising the B-staged monomers at 10 to 30 percent solids via a pipette. The cloth is thoroughly soaked with the solution and any excess is removed using the pipette. A heat deflector and oven are attached and a nitrogen flow of 3 standard cubic feet per hour (0.009 m³/h) is established. Amplitude of the displacement is set to 1.00 mm and frequency is set to 1 Hz. The sample is heated to 500° C. at 5° C. per minute and then allowed to cool. Data is collected during both the heating and cooling stages. Data analysis may be performed to obtain temperature versus flexural storage modulus values for the composite of glass and formulation. Prepared software programs such as DMA Standard Data Analysis Version 4.2 from DuPont or Universal Analysis for Windows 95/98/NT Version 2.5H from TA Instruments, Inc., may be used to perform the data analysis. The flexural storage modulus values themselves are not absolute values for the tested formulation due to the contribution of the glass cloth and the unavoidable variation in sample loading. However, qualitative assessment of one matrix system versus another can be made if the differences are significant.

Although not wishing to be bound by theory, it is believed that upon heating a solvent containing mixture according to the invention, the initial solvent loss leads to an increase in the flexural storage modulus of the cloth/matrix composite. After further heating the flexural storage modulus begins to decrease as the temperature of the scan reaches and then exceeds the glass transition temperature of the mixture of the B-staged monomers. As the precursor compounds begin to react or cure the modulus again increases and then levels out as cure is complete. Upon cool-down the flexural storage modulus slowly increases in a fairly linear manner. If a significant drop in flexural storage modulus is observed between 300 and 400° C. during cure, pore collapse problems may result. The flexural storage modulus, Mmin, for the formulations of this invention may be greater than that which occurs in conventional formulations and/or Mmin may occur at a lower temperature, Tmin, for example, less than 375° C. When employed in formulations including a poragen, this fact helps avoid pore collapse because it is less likely that significant degradation of the poragens will have occurred prior to reaching Tmin and/or the modulus will be sufficient to maintain the porosity.

Suitable solvents for use in preparing spin coating formulations of the monomers herein include known solvents useful in processing thermoset polyarylene precursor compositions. The solvent may be a single solvent or a mixture of one or more solvents. Examples include mesitylene, pyridine, triethylamine, N-methylpyrrolidinone (NMP), methyl benzoate, ethyl benzoate, butyl benzoate, cyclopentanone, cyclohexanone, cycloheptanone, cyclooctanone, cyclohexylpyrrolidinone, and ethers or hydroxy ethers such as dibenzylethers, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether, toluene, xylene, benzene, dipropylene glycol monomethyl ether acetate, dichlorobenzene, propylene carbonate, naphthalene, diphenyl ether, butyrolactone, dimethylacetamide, dimethylformamide and mixtures thereof.

Suitable poragens for use herein include any compound that can form small domains in a matrix formed from the precursors and which can be subsequently removed, for example by thermal decomposition. Preferred poragens are polymers including homopolymers and interpolymers of two or more monomers including graft copolymers, emulsion polymers, and block copolymers. Suitable thermoplastic materials include polystyrenes, polyacrylates, polymethacrylates, polybutadienes, polyisoprenes, polyphenylene oxides, polypropylene oxides, polyethylene oxides, poly(dimethylsiloxanes), polytetrahydrofurans, polyethylenes, polycyclohexylethylenes, polyethyloxazolines, polyvinylpyridines, polycaprolactones, polylactic acids, copolymers of the monomers used to make these materials, and mixtures of these materials. The thermoplastic materials may be linear, branched, hyperbranched, dendritic, or star like in nature. The poragen may also be designed to react with the cross-linkable matrix precursor during or subsequent to B-staging to form blocks or pendant substitution of the polymer chain. For example, thermoplastic polymers containing reactive groups such as vinyl, acrylate, methacrylate, allyl, vinyl ether, maleimido, styryl, acetylene, nitrile, furan, cyclopentadienone, perfluoroethylene, benzocyclobutane (BCB), pyrone, propiolate, or ortho-diacetylene groups can form chemical bonds with the cross-linkable matrix precursor, and then the thermoplastic can be removed to leave pores. The poragen is desirably a material that results in formation of voids or pores in the matrix having an average pore diameter less than 200 nm, more preferably less than 100 nm, most preferably less than 50 nm. Suitable block copolymers include those wherein one of the blocks is compatible with cross-linked polymer matrix resin and the other block is incompatible therewith. Useful polymer blocks can include polystyrenes such as polystyrene and poly-x-methylstyrene, polyacrylonitriles, polyethylene oxides, polypropylene oxides, polyethylenes, polylactic acids, polysiloxanes, polycaprolactones, polyurethanes, polymethacrylates, polyacrylates, polybutadienes, polyisoprenes, polyvinyl chlorides, and polyacetals, and amine-capped alkylene oxides (commercially available as Jeffamine™ polyether amines from Huntsman Corp.).

Preferably, the matrix precursor grafts to the poragen. This may be accomplished by adding the poragens to the monomers prior to B-staging as residual functional groups on the poragen are available to react with reactive groups on the monomers. Alternatively, some B-staging may occur prior to addition of the poragen and the poragen may be grafted by subjecting the mixture to conditions sufficient to cause residual functional groups on the poragen to react with residual reactive groups in the B-staged reaction product. The mixture is then coated onto a substrate (preferably solvent coated as for example by spin coating by known methods). The matrix is cured and the poragen is removed by heating it past its thermal decomposition temperature. Porous films prepared in this manner are useful in making integrated circuit articles where the film separates and electrically insulates conductive metal lines from each other.

Highly preferred poragens are crosslinked polymers made by solution or emulsion polymerization. Such polymerization techniques are known in the art, for example, EP-A-1,245,586, and elsewhere. Very small crosslinked hydrocarbon based polymer particles have been prepared in an emulsion polymerization by use of one or more anionic-, cationic-, or non-ionic surfactants. Examples of such preparations may be found in J. Dispersion Sci. and Tech., vol. 22, No. 2-3, 231-244 (2001), “The Applications of Synthetic Resin Emulsions”, H. Warson, Ernest Benn Ltd., 1972, p.88, Colloid Polym. Sci., 269, 1171-1183 (1991), Polymer. Bull., 43, 417-424 (1999), and WO 2003 070777, published Aug. 28, 2003, among other sources.

The compositions of the invention may be used to make dielectric films and interlayer dielectrics for integrated circuits in accordance with known processes, such as those of U.S. Pat. No. 5,965,679. To make a porous film the poragen is preferably removed by thermal decomposition of the poragen.

The following examples are for illustrative purposes only and are not intended to limit the scope of this invention. In particular, the skilled artisan will appreciate that the following preparation may be readily altered to provide monomers according to the invention containing a wide number, type and combination of substituted ethynyl and substituted cyclopentadienone ligands.

### EXAMPLES

Preparation of Reagents

### A) Synthesis of O,O′-Phenylethynylphenylbenzil

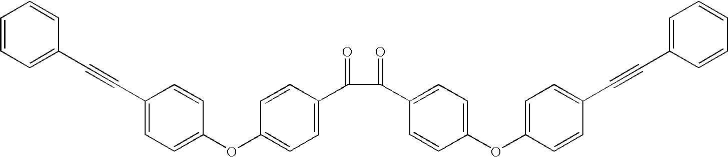

To a stirred suspension of AlCl₃ (66.5 g, 0.5 mole) in CH₂Cl₂ (200 ml) at 0° C. is added dropwise, a mixture of bromodiphenylether (109.6 g, 0.44 mole) and oxalyl chloride (25.2 g, 0.2 mole) over a period of 45 minutes. After the addition is completed, the reaction mixture is stirred at 0° C. for another 4 hours and then slowly poured into 1 liter of ice/water. The resulting product is extracted with 800 ml of toluene and dried over Na₂SO₄. Upon evaporation of solvents, a yellow solid is obtained, which is pure enough for the next step of reaction. Yield 93.2 g, 84 percent.

To a 500 ml round flask is added O,O′-dibromophenylbenzil (27.6 g, 0.05 mole) from the above reaction, DMF (60 ml), phenylacetylene (15 g, 0.147 mole), and triethylamine (30 g, 0.297 mole). The resulting mixture is purged with nitrogen for 15 minutes, and then triphenylphosphine (0.60 g, 0.0023 mole) and palladium acetate (0.1 g, 0.00045 mole) are added. The reaction mixture is heated to 80° C. for 18 hours. After cooling to room temperature, water (200 ml) is added. The crude product is filtered and the solid redissolved into toluene/hexanes. Upon evaporation of the solvent, yellow crystals are obtained which can be further recrystallized from ethylacetate/hexanes. Yield 21.5 g, 72 percent.

### B) Synthesis of 4,4′-Phenylethynylbenzil

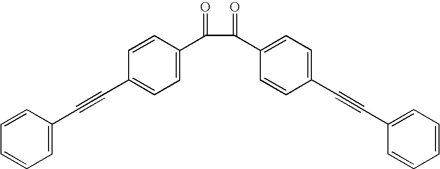

To a 250 ml round flask is added 4,4′-dibromobenzil (18.4. g, 0.05 mole), DMF (60 ml), phenylacetylene (12.2 g, 0.12 mole), and triethylamine (29 g, 0.24 mole). The resulting mixture is purged with nitrogen for 15 minutes, and then triphenylphosphine (0.60 g, 0.0023 mole) and palladium acetate (0.0829 g, 0.00037 mole) are added. The reaction mixture is heated to 80° C. for 10 hours. After cooling to room temperature, water (200 ml) is added. The crude product is filtered and the solid redissolved into toluene/hexanes. Upon evaporation of the solvent, yellow crystals are obtained which can be further recrystallized from ethylacetate/hexanes. Yield 15.3 g, 75 percent.

### C) Synthesis of 1-(4-Phenylethynylphenyl)-3-phenyl-2-Propanone

### 1. Ethyl 4-Bromophenylacetate

A solution of 63 grams (0.29 mole) of 4-bromophenyl acetic acid and 50 ml of concentrated sulfuric acid in 500 ml of absolute ethanol is refluxed for 8 hours then allowed to stand overnight. After pouring over 600 grams of ice, the mixture is extracted with ether/hexanes. The ether extracts are washed thoroughly with water and sodium bicarbonate solution then dried over anhydrous sodium sulfate. Removal of the solvent by rotary evaporation yields 57 grams (0.24 mole, 80 percent isolated yield) of an oil which crystallizes upon cooling. Filtration and washing with hexane affords highly pure product.

### 2. Synthesis of γ-(4-bromophenylaceto)-α-phenylacetonitrile

Sodium (6.0 grams, 0.26 mole) is added to 90 ml of absolute ethanol in a 250 ml three necked flask equipped with a stirrer, a condenser and a dropping funnel. While this solution is refluxing with stirring, a mixture of 30.37 grams of ethyl 4-bromophenyl acetate (0.125 mole) and benzyl cyanide (17.5 grams, 0.15 mole) is added through the dropping funnel over a period of 1 hour. The solution is refluxed for 3 hours, cooled, then poured into 400 ml of cold water. The aqueous alkaline solution is extracted three times with 100 ml portions of diethylether and the ether extracts discarded. The aqueous solution is acidified with cold 10 percent aqueous hydrochloric acid then extracted three times with 100 ml portions of ether. The ether solution is then extracted once with 100 ml of water, twice with 100 ml portions of 10 percent aqueous sodium bicarbonate solution and once with 100 ml of water, the aqueous extracts being discarded in turn. The organic phase is dried over anhydrous sodium sulfate, filtered through a fluted filter, and the ether removed by rotary evaporation. The desired product (33 grams) is recovered in 89 percent isolated yield.

### 3. Synthesis of 1-(4-bromophenyl)-3-phenyl-2-propanone

In a 250 three-necked flask equipped with a stirrer and a condenser are placed 75 ml of 60 percent aqueous sulfuric acid and 30 grams of the acetonitrile derivative prepared above. While being stirred, the mixture is heated at reflux until the evolution of carbon dioxide ceases. The mixture is cooled, poured into 200 ml of ice water, then extracted three times with 150 ml portions of diethylether. The ether extract is washed once with 50 ml of water, twice with 100 ml portions of 10 percent aqueous sodium hydroxide, and then with 50 ml of water. After drying over anhydrous sodium sulfate and filtering, the ether is removed by rotary evaporation, affording crude product. Recrystallization from 160 ml of hexanes gives 11.5 grams (42 percent isolated yield) of product as a colorless solid.

### 4. Synthesis of 1-(4-phenylethynylphenyl)-3-phenyl-2-propanone

In a 250 ml flask are placed 10.9 grams (0.04 mole) of 1-(4-bromophenyl)-3-phenyl-2-propanone, 10 grams (0.10 mole) of triethylamine, 4.6 grams (0.045 mole) of phenylacetylene, and 50 ml of N,N-dimethylformamide. The reaction mixture is purged with nitrogen for 15 minutes, then 0.47 gram (0.0018 mole) of triphenylphosphine and 0.067 gram (0.0003 mole) of palladium acetate are added. After heating the reaction mixture at 80° C. under a nitrogen atmosphere for 2 hours, the flask is allowed to cool to room temperature, and water (200 ml) and diethylether (200 ml) are added. The resulting organic layer is washed with 10 percent aqueous HCl, water and saturated aqueous NaCl then dried over anhydrous Na₂SO₄. The relatively pure product (8.5 grams, 72 percent isolated yield ) is obtained upon removal of the ether and recrystallization from toluene/hexanes.

### D) Synthesis of 1,3-bis(4-phenylethynylphenyl)-2-propanone

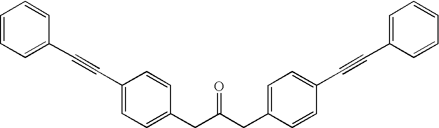

To a slurry of sodium hydride (9.17 grams, 0.23 mole) in 50 ml of toluene is added dropwise, a solution of ethyl 4-bromophenylacetate (50 grams, 0.21 mole) in toluene (50 ml) at 30-32° C. After addition is completed, the reaction mixture is slowly warmed to 50° C. where the reaction begins to rapidly exotherm with evolution of hydrogen gas. The reaction mixture is further heated to 78° C. for 2 hours, cooled to room temperature and then hydrochloric acid (45 grams) in water (22.5 grams) is slowly added dropwise to neutralize the solution. The layers are separated and the aqueous phase extracted with diethylether. The combined organic extracts are dried and the solvent removed to leave a yellow oil. This oil is refluxed for 24 hours in a mixture of glacial acetic acid (60 ml) and concentrated HCl (30 ml). After cooling, the layers are separated, and the organic layer solidified to provide a yellow solid. This crude product is recrystallized from n-heptane to give a pure product as a white solid (31.2 grams, 82 percent isolated yield).

In a 250 ml flask are placed 18.4 grams (0.05 mole) of 1,3-bis-(4-bromophenyl)-2-propanone, 24 g (0.24 mole) of triethylamine, 12 g (0.12 mole) of phenylacetylene, and 60 ml of N,N-dimethylformamide. The reaction mixture is purged with nitrogen for 15 minutes then 0.60 gram (0.0023 mole) of triphenylphosphine and 0.08 gram (0.00036 mole) of palladium acetate are added. After heating the reaction mixture at 80° C. under a nitrogen atmosphere for 20 hours, the flask is allowed to cool to room temperature, then water (200 ml) and toluene (200 ml) are added. The resulting organic layer is washed with 10 percent aqueous HCl, water and saturated aqueous NaCl, then dried over anhydrous Na₂SO₄. The relatively pure product (14.5 g) is obtained upon removal of the toluene and recrystallization from toluene/hexanes in 71 percent isolated yield.

### E) Synthesis of 1,3-bis(3,5-di(phenylethynyl)phenyl)-2-propanone

In a 250 ml flask is placed 26.3 g (0.05 mole) of 1,3-bis-(3,5-dibromophenyl)-2-propanone, 24 g (0.24 mole) of triethylamine, 20.4 g (0.20 mole) of phenylacetylene, and 60 ml of N,N-dimethylformamide. The reaction mixture is purged with nitrogen for 15 minutes then 0.60 g (0.0023 mole) of triphenylphosphine and 0.08 g (0.00036 mole) of palladium acetate are added. After heating the reaction mixture at 80° C. under a nitrogen atmosphere for 20 hours, the flask is allowed to cool to room temperature, then water (200 ml) and toluene (200 ml) are added The resulting organic layer is washed with 10 percent aqueous HCl, water and saturated aqueous NaCl then dried over anhydrous Na₂SO₄. The desired product (16.0 g) is obtained upon removal of the toluene and recrystallization from toluene/hexanes.

### Example 1

### Synthesis of 2-(4-phenylethynylphenyl)-3,4-di((4-phenylethynyl)-4-phenoxyphenyl)-5-phenyl-2,4-cyclopentadienone (A₃B monomer)

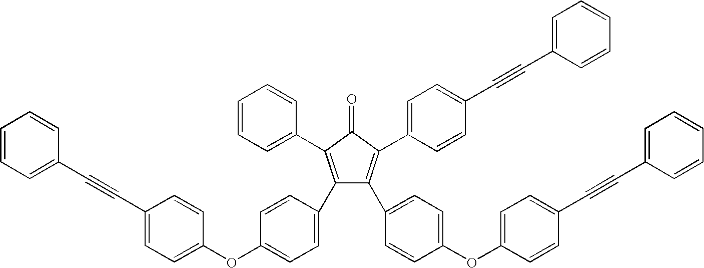

O,O′-phenylethynylphenylbenzil (Reagent A) (1.45 grams, 0.00244 mole) and 0.76 grams (0.0025 mole) of 1-(4-phenylethynylphenyl)-3-phenyl-2-propanone (Reagent C)) are added to a reactor containing 100 ml of anhydrous 1-propanol. Stirring and heating are commenced, and once the suspension reaches reflux temperature, benzyltrimethylammonium hydroxide (40 percent in methanol 0.2 ml in two 0.1 ml portions) is added, immediately inducing a deep red purple color. After maintaining at reflux for 40 minutes, HPLC analysis indicates that full conversion of the O,O′-phenylethynylphenylbenzil reactant has been achieved. At this time, the oil bath is removed from the reactor, and the reaction mixture allowed to cool to 40° C. The product is recovered via filtration through a medium fritted glass funnel. The crystalline product on the funnel is washed with two 100 ml portions of 1-propanol, then dried in a vacuum oven to provide 1.6 g (75 percent isolated yield) of the desired monomer.

### Example 2

### Synthesis of 2,5-di-(4-phenylethynylphenyl)-3,4-di((4-phenylethynyl)-4-phenoxyphenyl)-2,4-cyclopentadienone (A₄B monomer)

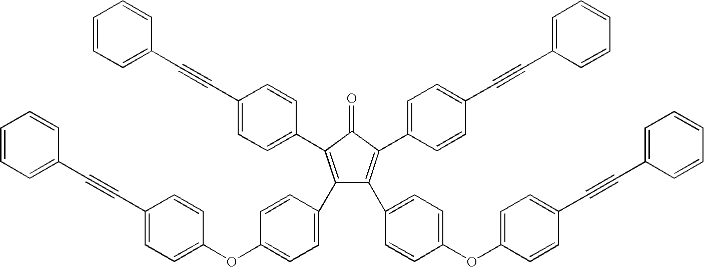

O,O′-phenylethynylphenylbenzil (Reagent A) (2.92 g, 0.0049 mole) and 2.0 g (0.0049 mole) of 1,3-bis(4-phenylethynylphenyl)-2-propanone (Reagent D) are added to a reactor containing 100 ml of anhydrous 1-propanol. Stirring and heating are commenced, and once the suspension reaches reflux temperature, benzyltrimethylammonium hydroxide (40 percent in methanol, 0.55 ml in two portions) is added, immediately inducing a deep red purple color. After maintaining at reflux for 2 hours, HPLC analysis indicates that full conversion of the O,O′-phenylethynylphenylbenzil reactant has been achieved. At this time, the oil bath is removed from the reactor, and the reaction mixture are allowed to cool to 40° C. The product is recovered via filtration through a medium fritted glass funnel. The crystalline product on the funnel is washed with two 100 ml portions of 1-propanol, then dried in a vacuum oven to provide 3.8 g (80 percent isolated yield) of the desired monomer.

### Example 3

### Synthesis of 2,3,4-tri-(4-phenylethynylphenyl)-5-phenyl-2,4-cyclopentadienone (A₃B monomer)

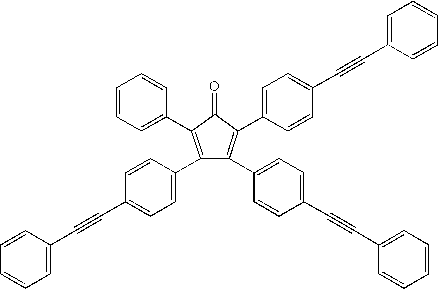

4,4′-Phenylethynyllbenzil (Reagent B) (1.0 g, 0.0025 mole) and 0.76 g (0.0025 mole) of 1-(4-phenylethynylphenyl)-3-phenyl-2-propanone (Reagent C) are added to a reactor containing 100 ml of anhydrous 1-propanol. Stirring and heating are commenced, and once the suspension reaches reflux temperature, benzyltrimethylammonium hydroxide (40 percent in methanol, 0.20 ml in two portions) is added, immediately inducing a deep red purple color. After maintaining at reflux for 1 hour, HPLC analysis indicates that full conversion of the 4,4′-phenylethynylbenzil reactant has been achieved. At this time, the oil bath is removed from the reactor, and the reaction mixture allowed to cool to 40° C. The product is recovered via filtration through a medium fritted glass funnel. The crystalline product on the funnel is washed with two 100 ml portions of 1-propanol, then dried in a vacuum oven to provide 1.1 g (66 percent isolated yield) of the desired 4,4′-A₃B monomer.

### Example 4

### Synthesis of 2,3,4,5-tetrakis-(4-phenylethynylphenyl)-2,4-cyclopentadienone (A₄B monomer)

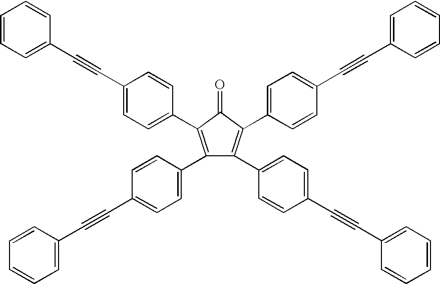

4,4′-Phenylethynylbenzil (Reagent B) (2.0 g, 0.0049 mole) and 2.0 g (0.0049 mole) of 1,3-bis(4-phenylethynylphenyl)-2-propanone (Reagent D) are added to a reactor containing 100 ml of anhydrous 1-propanol. Stirring and heating is commenced, and once the suspension reaches reflux temperature, benzyltrimethylammonium hydroxide (40 percent in methanol, 0.35 ml in two portions) is added, immediately inducing a deep red purple color. After maintaining at reflux for 1.5 hours, HPLC analysis indicates that full conversion of the 4,4′-phenylethynylbenzil reactant has been achieved. At this time, the oil bath is removed from the reactor, and the reaction mixture allowed to cool to 40° C. The product is recovered via filtration through a medium fritted glass funnel. The crystalline product on the funnel is washed with two 100 ml portions of 1-propanol, then dried in a vacuum oven to provide 3.0 g (78 percent isolated yield) of the desired monomer.

Differential scanning calorimetry (DSC) is completed using 2.2 mg of the foregoing monomer. A 2910 Modulated DSC (TA Instruments) is employed using a heating rate of 10° C./min from 25° C. to 450° C. under a stream of nitrogen flowing at 45 cm³/min. A small single endothermic transition is observed with a minimum at 266° C. and a strong single exothermic transition, attributable to cycloaddition reaction of phenylethynyl groups with tetraphenylcyclopentadienone groups with a maximum at 270° C. (115.4 joules per g). The onset temperature for this exothermic transition is 267° C., while the ending temperature is 297° C. Finally, a single/broad exothermic transition, attributable to self-cure reaction of phenylethynyl groups, is observed with a maximum at 401° C. (144 jouls per g).

### Example 5

### Synthesis of 2,5-bis-(3,5-di(phenylethynyl)phenyl)-3,4-bis[4-(4-phenylethynyl)phenoxyphenyl]-2,4-cyclopentadienone (A₆B monomer)

O,O′-phenylethynylphenylbenzil (Reagent A) (2.0 g, 3.3 mmole) and 2.0 g (3.3 mmole) of 1,3-bis(3,5-diphenylethynyl)phenyl)-2-propanone (Reagent E) are added to a reactor containing 100 ml of anhydrous I-propanol. Stirring and heating are commenced, and once the suspension reaches reflux temperature, benzyltrimethylammonium hydroxide (40 percent in methanol, 0.35 ml in two portions) is added. After maintaining at reflux for 1.5 hours, the oil bath is removed from the reactor, and the reaction mixture allowed to cool to 40° C. The product is recovered via filtration through a medium fritted glass funnel and washed with two 100 ml portions of I-propanol, then dried in a vacuum oven.

### Example 6

### Synthesis of2,5-bis-(3,5-di(phenylethynyl)phenyl)-3,4-bis[4-(4-phenylethynyl)phenyl]-2,4-cyclopentadienone (A₆B monomer)

The reaction conditions of Example 5 are substantially repeated using 4,4′-phenylethynylbenzil (Reagent B) (1.3 g, 3.3 mmol) and 2.0 g (3.3 mmole) of 1,3-bis(3,5-di(phenylethynyl)phenyl)-2-propanone (Reagent E).

### Example 7

### Polymerization and Thin Film Property Evaluation

To a 50 ml round flask are added 2.0 g of the monomer of Example 2 and 4.7 g of γ-butyrolactone and the resulting mixture heated at 200° C. under nitrogen during a period of 24 hours. After 1, 5, 7.5, 13, and 24 hours of B-stage reaction, samples of the solution are taken and analyzed by gel permeation chromatography (GPC) using polystyrene as the standard. Results are contained in Table 1

TABLE 1

| Run | Heating time (h) | Mn | Mw | Mw/Mn |
|---|---|---|---|---|
| 1 | 0 | 1060 | 1100 | 1.05 |
| 2 | 1 | 1490 | 2020 | 1.36 |
| 3 | 5 | 3260 | 6620 | 2.03 |
| 4 | 7.5 | 3960 | 9410 | 2.38 |
| 5 | 13 | 5260 | 14400 | 2.74 |
| 6 | 24 | 5240 | 17200 | 3.28 |

The solution obtained from Run 6 is diluted with cyclohexanone to make a 20 percent solution, applied to a silica wafer and cast by spin-coating to form a 0.48 μm thick film. The wafer is baked on a hotplate at 150° C. and then further heated to 430° C. under nitrogen for 40 minutes. A dielectric film is obtained with a refractive index of 1.65 and k value of 2.77.

### Example 8

### Preparation of Porous Film

To a 50 ml round bottom glass flask is added 2.0 g of the monomer from Example 4, 0.86 g of crosslinked polystyrene emulsion polymerized polymer (10 nm average particle size) and 4.7 g γ-butyrolactone. The resulting mixture is purged under nitrogen for 15 minutes and then heated to 200° C. under nitrogen for 13 hours. The mixture is then cooled to room temperature and diluted with 7.0 g of cyclohexanone to give a 17 percent mixture. The resulting B-staged oligomer is analyzed by (PC and found to have Mn of 4060 g/mole and Mw of 6260 g/mole with a polydispersity (Mw/Mn) of 1.54.

The solution of B-staged monomer is applied to a silica wafer and cast by spin-coating to form a 0.95 μm thick film. The wafer is baked on a hotplate at 150° C. and then further heated to 430° C. under nitrogen for 40 minutes in an oven. A porous film is obtained with a refractive index of 1.478, k value of 2.23 and an estimated average pore size of 20 nm based on visual inspection of a photograph obtained by transmission electron microscopy.

### Example 9

### 2,5-diphenyl-3-[4-(2,4,6-tris(phenylethynyl)phenoxy)phenyl]-5-(3,5-bis(phenylethynyl)phenyl)-2,4-cyclopentadienone (A₅B monomer)

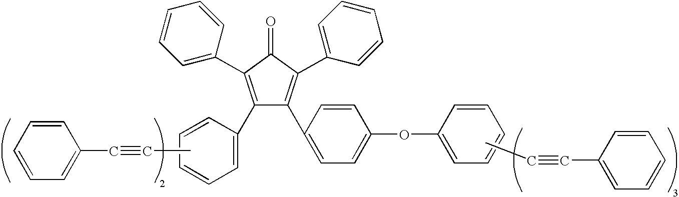

### A. Synthesis of 2,4,6-tribromodiphenyl oxide

2,4,6-Tribromophenol (9.93 g, 0.03 mole), diphenyliodonium chloride (9.5 g, 0.03 mole), sodium hydroxide (99.99 percent, 1.2 g, 0.03 mole) and deionized water (240 g) are added to a 500 ml glass, single neck round bottom reactor containing a magnetic stirring bar. The reactor is additionally outfitted with chilled (2° C.) condenser and a thermostatically controlled heating mantle. Stirring and heating are commenced, and after 37 minutes a refluxing clear solution with a trace of suspended yellow particles formes. After a cumulative 62 minutes heating, a refluxing light amber oil suspended in a clear solution forms. After a cumulative 24 hours at reflux, the reaction mixture is cooled to room temperature, and the aqueous layer decanted and discarded. The remaining product is dissolved into diethylether (200 ml). The diethylether solution is washed in a separatory funnel with 10 percent aqueous sodium hydroxide (50 ml), followed by drying over anhydrous sodium sulfate and filtration through a medium fritted glass funnel. Rotary evaporation of the resulting filtrate provides an off-white solid containing 75 area percent of the desired product as determined via high pressure liquid chromatographic analysis (HPLC). The product is boiled in 200 ml ethanol to provide a hazy solution which is passed through a bed of diatomaceous earth packed in a fritted glass funnel. The resultant filtrate is recovered and reheated to boiling followed by the addition of just enough deionized water to induce a slight cloudiness. Slow cooling to room temperature provides a suspension of transparent needle-like crystals which are recovered via filtration and dried at 25° C. in a vacuum oven to a constant weight of 6.3 g. Chilling the filtrate (4° C.) provides a second crop (0.9 g) of crystalline product. BPLC analysis of both crops of product reveals the presence of the desired 2,4,6-tribromodiphenyl oxide at 100 area percent. Electron ionization mass spectroscopic analysis (EI MS) confirms the structure of the product.

### B. Acylation of 2,4,6-Tribromodiphenyl oxide with 3,5-Dibromophenylacetyl Chloride

2,4,6-Tribromodiphenyloxide (7.13 g, 0.0175 mole), aluminum chloride (2.57 g, 0.0193 mole) and anhydrous 1,2-dichloroethane (40 milliliters) are added under a dry nitrogen atmosphere to a predried 250 ml glass, three neck reactor containing a predried magnetic stirring bar. The reactor is sealed under nitrogen, then placed on a Schlenk line. Under a dry nitrogen atmosphere 3,5-dibromophenylacetyl chloride (5.58 g, 0.0175 mole) is dissolved in 1,2-dichloroethane (19 ml) then added to a predried addition funnel which is then sealed under nitrogen and placed on the Schlenk line. The addition funnel and reactor are coupled under dynamic nitrogen flow. An ice bath is placed under the reactor, stirring commenced, and 20 minutes later 3,5-dibromophenylacetyl chloride solution is added dropwise to the stirred mixture. After 52 minutes, the addition is completed and after a cumulative 172 minutes, HPLC analysis of a sample of the reaction product demonstrates complete conversion of the reactants to the desired acylation product. After a cumulative 196 minutes, chilled deionized water (100 ml) is added to the reaction mixture followed by the addition of dichloromethane (50 ml). The entire contents of the reactor are then added to a separatory funnel along with additional dichloromethane (350 ml) to obtain a transparent organic layer. The aqueous layer is removed and discarded, followed by washing of the remaining organic layer with deionized water (100 ml). The recovered organic layer is dried over anhydrous sodium sulfate, then filtered through a medium fritted glass funnel. Rotary evaporation of the resultant filtrate provides 11.93 g of a white powder product. BLC analysis of the product reveals the presence of 99.3 area percent of the desired 1-(2′,4′,6′-tribromophenoxy)-4-(3″,5′-dibromophenylacetyl)benzene accompanied by a single co-product comprising the balance of the area.

### C. Oxidation of 1-(2′,4′,6′-tribromophenoxy)-4-(3″,5′-dibromophenylacetyl)benzene

1-(2′,4′,6′-Tribromophenoxy)-4-(3″,5′-dibromophenylacetyl)benzene (11.9 g, 0.0175 mole), and dimethylsulfoxide (300 milliliters) are added to a 500 ml glass three neck reactor containing a magnetic stirring bar. The reactor is additionally outfitted with a condenser set at room temperature and vented into a scrubber, a thermometer, a thermostatically controlled heating mantle, and an additional funnel charged with 48 percent aqueous hydrobromic acid (20.6 g). Stirring is commenced, then the aqueous hydrobromic acid is added as a stream over a one minute period, inducing a maximum exotherm of 31° C. Two minutes later, gentle heating is commenced and after 68 minutes, the reactor contents reach 100° C. After 2 hours at 100° C., HPLC analysis of a sample of the reaction product demonstrates complete conversion of the reactant to the desired oxidation product. After an additional 22 minutes, the reaction product is poured into stirred deionized water (2.5 liters). After stirring overnight, the slurry is filtered through a fine fritted glass funnel, followed by washing of the product on the filter with deionized water (200 ml). The product on the filter is dried (60° C.) in the vacuum oven to a constant weight of 8.86 g. The product is boiled as a slurry in acetonitrile (200 ml) then cooled to room temperature and recovered via filtration on a medium fitted glass funnel. After drying (60° C.) the solid product recovered from the filter in a vacuum oven, 8.56 g of light yellow powder product are recovered. HPLC analysis of the product reveals the presence of 100 area percent of the desired 1-(2′,4′,6′-tribromophenoxy)-4-(3″,5′-dibromophenylglyoxalyl)benzene. EI MS conforms the structure of the product.

### D. Phenylethynylation of 1-(2′,4′,6′-tribromophenoxy)-4-(3″,5′-dibromophenylglyoxalyl)benzene

1-(2′,4′,6′-Tribromophenoxy)-4-(3″,5′-dibromophenylglyoxalyl)benzene (8.56 g, 0.0123 mole, 0.0614 -Br equivalent), phenylacetylene (7.58 g, 0.0742 mole), anhydrous triethylamine (16.97 g, 0.1677 mole) which had been sparged with nitrogen, triphenylphosphine (0.41 g, 0.0016 mole), palladium (II) acetate (0.056 g, 0.00025 mole) and anhydrous N,N-dimethylformamide (200 g) which had been sparged with nitrogen are added under a dry nitrogen atmosphere to a predried one liter glass three neck round bottom reactor containing a predried magnetic stirring bar. The reactor is additionally outfitted with fan cooled spiral condenser and a thermometer with a thermostatically controlled heating mantle. Stirring and heating of the yellow slurry is commenced and after 18 minutes a temperature of 57° C. is achieved, and a light amber solution forms. Heating is continued until a temperature of 80° C. is achieved, which temperature is maintained for the next 17 hours. At this time, HPLC analysis indicats that full conversion of the 1-(2′,4′,6′-tribromophenoxy)-4-(3″,5′-dibromophenylglyoxalyl)benzene reactant has been achieved. The reactor contents are poured into a beaker containing stirred, deionized water (2.5 liters). After stirring overnight, the precipitated product is recovered via filtration through a medium fritted glass funnel. The product cake on the funnel is washed with two portions (100 ml) of deionized water, then allowed to air dry on the filter to provide 11.2 g of light cream colored powder (still slightly damp). HPLC analysis reveals the presence of the desired 1-[2′,4′,6′-tris(phenylethynyl)-phenoxy]4-[3″,5′-bis(phenylethynyl)phenylglyoxalyl]-benzene product at 100 area percent.

### E. Conversion of 1-[2′,4′,6′-tris(phenylethynyl)phenoxy]-4-[3″,5′-bis(phenylethynyl)phenylglyoxalyl]benzene to the A₅B Monomer

1-[2′,4′,6′-tris(phenylethynyl)phenoxy]-4-[3,5′-bis(phenylethynyl)phenylglyoxalyl]-benzene (11.2 g, 0.0123 mole theoretical), 1,3-diphenylacetone (2.91 g, 0.0138 mole), 2-propanol (172 milliliters) and toluene (77 milliliters) are added under a dry nitrogen atmosphere to a 500 ml glass three neck round bottom reactor containing a magnetic stirring bar. The reactor is additionally outfitted with a Claisen adaptor, chilled (2° C.) condenser, a thermometer, a thermostatically controlled heating mantle, a nitrogen sparge tube, and an addition funnel charged with a solution of 0.94 ml of tetrabutylammonium hydroxide (1 M in methanol) in 2-propanol (18.6 ml). Stirring, heating and sparging with nitrogen are commenced, and after 68 minutes, a gentle reflux temperature of 79° C. is achieved. At this time, nitrogen sparging ceases, being converted to overhead nitrogen, and dropwise addition of the tetrabutylammonium hydroxide catalyst solution to the light tan colored thin slurry is commenced. After 17 minutes, all catalyst solution is added inducing the formation of a maroon colored thin slurry. After a cumulative 27 minutes, a dark red purple colored solution forms. After a cumulative 125 minutes of reaction, HPLC analysis indicates that optimum conversion to the A₅B monomer has occurred and the heating mantle is removed from the reactor, followed by addition of 2-propanol (150 ml) to the reactor and cooling of the reactor exterior with a fan. After cooling to 25° C., the product is recovered via filtration through a medium fritted glass funnel. The product cake on the funnel is washed with 2-propanol (50 ml), then dried (40° C.) in a vacuum oven to provide 9.59 g (79.9 percent isolated yield) of the A₅B monomer as a dark red purple colored crystalline product. BPLC analysis reveals the presence of the desired product at 93.4 area percent.

### Example 10

### Polyarylene Polymer Formation

Differential scanning calorimetry (DSC) is conducted using a 4.0 mg portion of the A₅B monomer from Example 9. A DSC 2920 Modulated DSC (TA Instruments) is employed, using a heating rate of 7° C./min from 25° C. to 500° C. under a stream of nitrogen flowing at 45 cm³/min. A slight endothermic transition associated with melting is observed at the onset to the exothermic transition which follows. A single exothermic transition (with shouldering on both the peak front and back), attributable to Diels Alder reaction of phenylethynyl groups with cyclopentadieneone groups, is observed with a maximum at 230.0° C. (109.5 joules/g). A second exothermic transition, attributable to reaction of phenylethynyl groups, is observed with a maximum at 379.6° C. (166.9 joules/g). The onset temperature for this exothermic transition is 325.7° C., immediately following the end of the transition associated with the aforementioned Diels-Alder reaction. The sample recovered from the DSC analysis is a rigid dark amber colored fused transparent solid.

### Example 11

### 2,5-diphenyl-3-[4-(4-(phenylethynyl)phenoxy)phenyl]-5-(3,5-bis(phenylethynyl)phenyl)-2,4-cyclopentadienone (A₃B monomer)

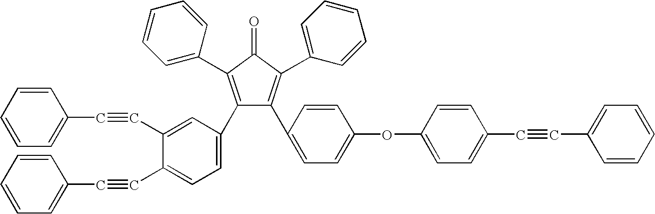

### A. Acylation of 4-bromodiphenyl oxide with 3,5-dibromophenylacetyl chloride

4-Bromodiphenyl oxide (12.46 g, 0.05 mole), 3,5-dibromophenylacetyl chloride (15.62 g, 0.05 mole) and anhydrous 1,2-dichloroethane (50 ml) are added under a dry nitrogen atmosphere to a predried 500 ml glass single neck round bottom reactor containing a predried magnetic stirring bar. Under a dry nitrogen atmosphere, aluminum chloride (8.00 g, 0.06 mole) is added in 0.5 g aliquots every 5 minutes to the stirred slurry in the reactor which is maintained at 23° C. During the course of these aluminum chloride additions, the product in the reactor transforms from a slurry to a red orange colored solution. After 125 minutes of post reaction, HPLC analysis of a sample of the reaction product demonstrates no further conversion of the reactants to the desired acylation product. After a cumulative 157 minutes of post reaction, the reaction product is poured over ice contained in a 2 liter beaker followed by the addition of dichloromethane (500 ml). Once the ice melts, the mixture is added to a separatory funnel and the aqueous layer is removed and discarded, followed by washing of the remaining organic layer with deionized water (200 ml). The recovered organic layer is dried over anhydrous sodium sulfate, then filtered through a medium fritted glass funnel. Rotary evaporation of the resultant filtrate provides 28.30 g of a white powder product. A minor amount of 3,5-dibromophenylacetic acid is removed from the product by dissolving the product in dichloromethane (250 ml) followed by extraction with aqueous potassium hydroxide (0.15 mole active KOH dissolved into 100 ml of deionized water). After washing the dichloromethane solution with deionized water (100 ml) followed by drying over anhydrous sodium sulfate and filtration through a medium fritted glass funnel, rotary evaporation of the filtrate provides 21.41 g of 1-(4′-bromophenoxy)-4-(3″,5″-dibromophenylacetyl)benzene (along with 5.80 g of potassium 3,5-dibromophenyl acetate recovered from the aqueous extract).

### B. Oxidation of 1-(4′-bromophenoxy)-4-(3″,5″-dibromophenylacetyl)benzene

1-(4′-Bromophenoxy)-4-(3″,5″-dibromophenylacetyl)benzene (21.4 g, 0.0408 mole), and dimethylsulfoxide (400 ml) are added to a one liter glass three neck round bottom reactor containing a magnetic stirring bar. The reactor is additionally outfitted with a condenser operating at room temperature and vented into a scrubber, a thermometer, a thermostatically controlled heating mantle, and an addition funnel charged with 48 percent aqueous hydrobromic acid (48.12 g). Stirring is commenced, then the aqueous hydrobromic acid is added as a stream over a four minute period to the 37° C. solution, inducing a maximum exotherm of 48° C. One minute later, gentle heating is commenced and after 38 minutes, the reactor contents reach 100° C. After 110 minutes at 100° C., HPLC analysis of a sample of the reaction product demonstrates complete conversion of the reactant to the desired oxidation product. After an additional 13 minutes, the reaction product is poured into stirred deionized water (3 liters). After stirring 3 hours, the slurry is filtered through a coarse fritted glass funnel, followed by washing of the product on the filter with deionized water (200 ml). The product on the filter is recovered as a damp product which is then dissolved in boiling acetone (150 ml) followed by cooling to room temperature. The resultant crystalline product which forms overnight is recovered via filtration on a medium fritted glass funnel. After drying (60° C.) the product from the filter in the vacuum oven, 11.85 g of light yellow colored fibrous crystalline product are recovered. A second crop (1.50 g) of crystalline product is recovered via rotary evaporation of the filtrate until a slightly hazy solution is obtained at room temperature, followed by holding at room temperature overnight, filtering and drying. HPLC analysis of the first crop product reveals the presence of 100 area percent of the desired 1-(4′-bromophenoxy)-4-(3″,5″-dibromophenylglyoxalyl)-benzene. BPLC analysis of the second crop reveals the presence of 97.0 area percent 1-(4′-bromophenoxy)-4-(3″,5″-dibromophenylglyoxalyl)benzene accompanied by 2 minor co-products. EI MS confirms the structure of the product.

### C. Phenylethynylation of 1-(4′-bromophenoxy)-4-(3″,5″-dibromophenylglyoxalyl)-benzene

A portion of the combined first and second crops of 1-(4′-bromophenoxy)-4-(3″,5″-dibromophenylglyoxalyl)benzene from B. above (13.15 g, 0.0244 mole, 0.0732 —Br equivalent), phenylacetylene (9.04 g, 0.0885 mole), anhydrous triethylamine (20.22 g, 0.20 mole) which is sparged with nitrogen, triphenylphosphine (0.49 g, 0.0019 mole), palladium (II) acetate (0.07 g, 0.00031 mole) and anhydrous N,N-dimethylformamide (233 g) which is sparged with nitrogen are added under a dry nitrogen atmosphere to a predried 500 ml glass three neck round bottom reactor containing a predried magnetic stirring bar. The reactor is additionally outfitted with a fan cooled spiral condenser and a thermometer with a thermostatically controlled heating mantle. Stirring and heating of the light golden yellow colored solution is commenced until a temperature of 80° C. is achieved which temperature is maintained for the next 18.5 hours. At this time, HPLC analysis indicates that full conversion of the 1-(4′-bromophenoxy)-4-(3″,5″-dibromophenylglyoxalyl)benzene reactant has been achieved. The reactor contents are poured into a beaker containing stirred, deionized water (3 liters). After stirring overnight, the precipitated product is recovered via filtration through a medium fritted glass funnel. The product cake on the funnel is washed with two portions (100 ml) of deionized water, then dried in the vacuum oven at room temperature to provide 17.24 g of yellow powder (still slightly damp). The product is boiled in reagent grade ethanol (4 liters) until a hazy solution forms followed by cooling to room temperature. The resultant crystalline product which forms overnight is recovered via filtration on a medium fritted glass funnel. After drying the recovered product at room temperature in a vacuum oven, 2.80 g of mustard yellow colored crystalline product are recovered. HPLC analysis reveals the presence of the desired 1-[4′-(phenylethynyl)phenoxy]-4-[3″,5′-bis(phenylethynyl)phenylglyoxalyl]-benzene product at 95.4 area percent.

### D. Conversion of 1-[4′-(phenylethynyl)phenoxy]-4-[3″,5′-bis(phenylethynyl)-phenylglyoxalyl]benzene to the A₃B Monomer

1-[4′-(phenylethynyl)phenoxy]-4-[3″,5 ′-bis(phenylethynyl)phenylglyoxalyl]benzene (1.83 g, 0.0030 mole), 1,3-diphenylacetone (0.72 g, 0.0034 mole) and 1-propanol (100 milliliters) are added under a dry nitrogen atmosphere to a 500 ml glass three neck round bottom reactor containing a magnetic stirring bar. The reactor is additionally outfitted with a Claisen adaptor, chilled (2° C.) condenser, a thermometer, a thermostatically controlled heating mantle, a nitrogen sparge tube, and a septum covered port for injection of 0.24 ml of tetrabutylammonium hydroxide (1 M in methanol). Stirring, heating and sparging with nitrogen are commenced, and after 45 minutes, a reflux temperature of 95° C. is achieved. At this time, nitrogen sparging is converted to overhead nitrogen, and injection of the tetrabutylammonium hydroxide catalyst solution to the yellow colored thin slurry is completed. Nine minutes after injection of the catalyst, a dark red solution forms, and HPLC analysis demonstrats complete conversion of the 1-[4′-(phenylethynyl)phenoxy]4-[3″,5′-bis(phenylethynyl)phenylglyoxalyl]-benzene to a single product attributed to A₃B monomer.

What is claimed is:

1. A compound comprising i) three or more dienophile groups (A-functional groups) and ii) a single ring structure comprising two conjugated carbon-to-carbon double bonds and a leaving group L (collectively referred to as a B-functional group), characterized in that one A-functional group of one molecule of the compound is capable of reaction under cycloaddition reaction conditions with the B-functional group of a second molecule and elimination of the leaving group L, to thereby form a polymer.

2. A compound according to claim 1 corresponding to the formula, 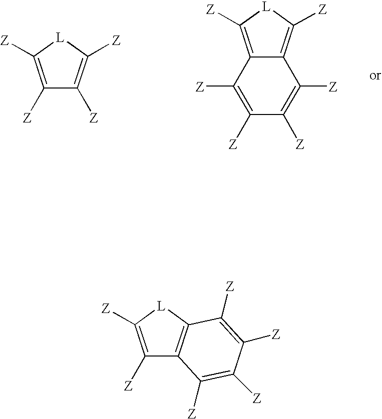
wherein L is —O—, —S—, —N═N—, —(CO)—, —(SO₂)—, or —O(CO)—;
Z is independently in each occurrence —W—(C≡C-Q)_{q}, hydrogen, halogen, an unsubstituted or inertly substituted aromatic group, an unsubstituted or inertly substituted alkyl group, or two adjacent Z groups together with the carbons to which they are attached form a fused aromatic ring;
W is an unsubstituted or inertly substituted C₆₋₂₀ aromatic group, Q is hydrogen, an unsubstituted or inertly substituted C₆₋₂₀ aryl group, or an unsubstituted or inertly substituted C₁₋₂₀ alkyl group;
q independently each occurrence is an integer from 1 to 3; and
the number of Z substituents and q are selected to provide a total of from 3 to 10 —C≡C-Q groups.

3. A compound according to claim 1 corresponding to the formula: 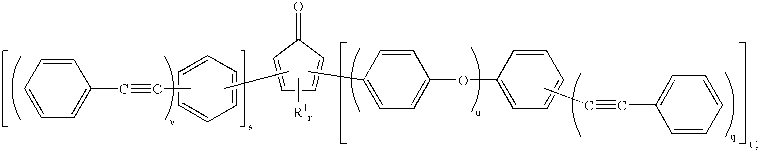
wherein R¹ is hydrogen, C₆₋₂₀ aryl or inertly substituted aryl;
q is a number from 1 to 3;
r is a number from 0 to 3;
u is 0 or 1;
v is a number from 1 to 3;
s and t are numbers from 1 to 4, and (v·s)+(q·t) is a number greater than or equal to 3; and r+s+t=4.

4. A compound according to claim 1 corresponding to the formula: 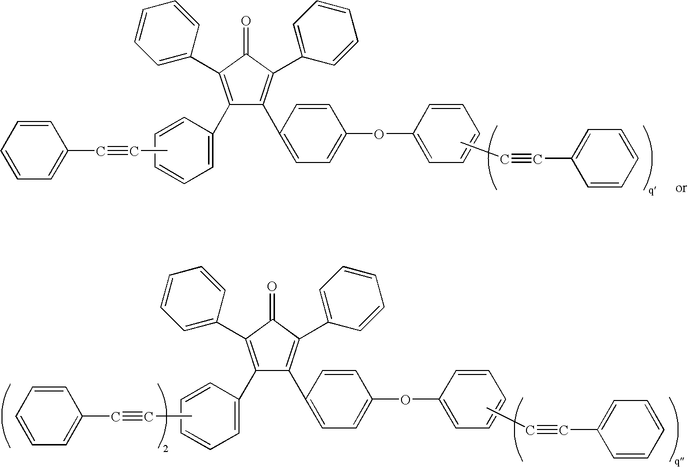
where q′ is a number from 2 to 3 and q″ is a number from 1 to 3.

5. A compound according to claim 1 selected from the group consisting of:
2-(4-phenylethynylphenyl)-3,4-di((4-phenylethynyl)-4-phenoxyphenyl)-5-phenyl-2,4-cyclopentadienone,
2,5-di-(4-phenylethynylphenyl)-3,4-di((4-phenylethynyl)-4-phenoxyphenyl)-2,4-cyclopentadienone,
2,3,4-tri-(4-phenylethynylphenyl)-5-phenyl-2,4-cyclopentadienone,
2,3,4,5-tetrakis-(4-phenylethynylphenyl)-2,4-cyclopentadienone,
2,5-bis-(3,5(phenylethynyl)phenyl)-3,4-bis[4-(4-phenylethynyl)phenoxyphenyl]-2,4-cyclopentadienone,
2,5-bis-(3,5-di(phenylethynyl)phenyl)-3,4-bis[4-(4-phenylethynyl)phenyl]-2,4-cyclopentadienone,
2,5-diphenyl-3-[4-(2,4,6-tris(phenylethynyl)phenoxy)phenyl]-5-(3,5-bis(phenylethynyl)phenyl)-2,4-cyclopentadienone, and
2,5-diphenyl-3-[4-(4-phenylethynylphenoxy)phenyl]-5-(3,5-bis(phenylethynyl)phenyl)-2,4-cyclopentadienone.

6. A spin-coatable, curable composition comprising a monomer according to any one of claims 1-5, an optional solvent, and an optional pore forming material.

7. A method of forming an insulating film on an electrical device comprising coating the device with a composition according to claim 6, removing the optional solvent, curing the monomer, and optionally removing the optional pore forming material.

8. An electrical device comprising an insulating film prepared according to claim 7.
